(19) United States
(12) Patent Application Publication
(10) Pub. No.: US 2025/0188339 A1
(43) Pub. Date: Jun. 12, 2025

(54) RED SAND DUNES SILICON NANOPARTICLES FOR GREEN ENHANCED OIL RECOVERY

(71) Applicant: KING FAHD UNIVERSITY OF PETROLEUM AND MINERALS, Dhahran (SA)

(72) Inventors: Md Bashirul HAQ, Dhahran (SA); Dhafer Abdullah AL SHEHRI, Dhahran (SA); Md. Abdul AZIZ, Dhahran (SA)

(73) Assignee: KING FAHD UNIVERSITY OF PETROLEUM AND MINERALS, Dhahran (SA)

(21) Appl. No.: 18/535,494

(22) Filed: Dec. 11, 2023

(51) Int. Cl. C09K 8/58

(52) U.S. Cl. CPC C09K 8/58

(57) ABSTRACT

A method for green enhanced oil recovery from a hydrocarbon reservoir in a subterranean geologic formation includes injecting a nanofluid composition including silicon oxide (SiO₂) nanoparticles (NPs), and xanthan gum into the geologic formation via an injection well and collecting the hydrocarbon composition from the reservoir via a production well. The hydrocarbon reservoir includes a hydrocarbon composition. The interfacial tension (IFT) of the hydrocarbon composition, and the nanofluid composition is about 48% to 55% less than the IFT of the hydrocarbon composition and a brine as determined by the pendant drop method.

### STATEMENT OF ACKNOWLEDGEMENT

This research was supported by the College of Petroleum and Geosciences (CPG) at King Fahd University of Petroleum and Minerals (KFUPM) under the Project SF19005, and the Interdisciplinary Research Center for Hydrogen and Energy Storage at KFUPM.

### BACKGROUND

### Technical Field

The present disclosure is directed to a method for recovery of crude oil, more particularly, an environmentally friendly method for enhancing oil recovery from hydrocarbon reservoirs.

### DESCRIPTION OF THE RELATED PRIOR ART

The description of the related prior art provided herein is for the purpose of generally presenting the context of the disclosure. Work of the presently named inventors, to the extent described in this background section, as well as aspects of the description which may not otherwise qualify as prior art at the time of filing, are neither expressly nor impliedly admitted as prior art against the present invention.

Oil recovery is a multi-step process for extracting oil and gas from a subterranean hydrocarbon reservoir. Typically, the production rate varies throughout the lifecycle of a reservoir or a well. Therefore, to achieve improved oil recovery, various techniques and technologies are employed at different phases, depending on the well's age, formation characteristics, and operational costs. As a result, oil recovery methods are categorized into three main groups: primary, secondary, and tertiary processes. In the primary recovery stage, the oil is produced by the natural reservoir energy. Following primary recovery, the secondary stage is introduced, involving methods such as water flooding, pressure maintenance, and gas injection. The tertiary process or enhanced oil recovery (EOR) is employed when extracting crude oil from an oil field becomes challenging using primary and secondary techniques, and there are still substantial quantities of oil remaining in the hydrocarbon reservoir. Several studies have suggested that during the oil production phase, over 50% of the original oil in place (OOIP) is left unrecovered (See: Muhammed N S, Haq M B, Al-Shehri D, Rahaman M M, Keshavarz A, Hossain S M Z. Comparative Study of Green and Synthetic Polymers for Enhanced Oil Recovery. Polymers (Basel)). This residual oil, which could be in the form of isolated oil droplets, oil film, residual oil in dead-ends, residual oil in pore throats, and clusters, is targeted through enhanced oil recovery (EOR) methods (See: Deng X, Tariq Z, Murtaza M, Patil S, Mahmoud M, Kamal M S. Relative contribution of wettability Alteration and interfacial tension reduction in EOR: A critical review. J Mol Liq 2021). EOR technique according to Green and Willhite (See: Green D W, Willhite P. Enhanced Oil Recovery. SPE: Richardson, TX, USA: 1998) entails the injection of fluids not normally present in the reservoir after primary and secondary production, whereas green EOR (GEOR) is the application of environmentally friendly agents for the enhancement of oil production (See: Al-ghamdi A, Haq B, Al-shehri D, Muhammed N S. Surfactant formulation for Green Enhanced Oil Recovery. Energy Reports 2022; 8:7800-13 and Haq B, Liu J, Liu K, Al Shehri D. The role of biodegradable surfactant in microbial enhanced oil recovery. J Pet Sci Eng 2020; 189:106688). Over the years, various conventional techniques, such as thermal, gas, and chemical agents, have been explored to recover the unproduced residual oil. These unconventional reserves are typically characterized by high capillary forces, high interfacial tension (IFT), wettability issues, and poor oil mobility (See: Kalam S, Abu-Khamsin S A, Kamal M S, Patil S. A review on surfactant retention on rocks: mechanisms, measurements, and influencing factors. Fuel 2021; 293:120459). Common chemical methods employed for this purpose include the use of surfactants, polymers, surfactant-polymer combinations, alkali-surfactant-polymer methods, and low salinity flooding techniques (See: Cheraghian G, Khalili Nezhad S S, Kamari M, Hemmati M, Masihi M, Bazgir S. Adsorption polymer on reservoir rock and role of the nanoparticles, clay and SiO₂. Int Nano Lett 2014; 4. And Abhishek R, Hamouda A A. Effect of various silica nanofluids: Reduction of fines migrations and surface modification of berea sandstone. Appl Sci 2017; 7).

In recent years, the integration of nanotechnology has opened new frontiers in the field of Enhanced Oil Recovery (EOR). Research findings from various experiments have demonstrated that properly designed nanofluids can help improve the recovery of hydrocarbon in the reservoirs (See: Bila A, Åge Stensen J, Torsæter O. Polymer-functionalized silica nanoparticles for improving waterflood sweep efficiency in Berea sandstones. E3S Web Conf 2020; 146). The primary mechanism behind the application of nanoparticles in the EOR process revolves around reducing Interfacial Tension (IFT), optimizing rheological properties, modifying wettability, and controlling the mobility of trapped oil—attributed to capillary forces and other critical factors. Given that the size of the pore throat is on the micron scale, nanoparticles (with particle sizes typically ranging from 1 to 100 nm) serve as ideal conduits due to their ability to easily permeate porous media (See: Al Hamad M, Sultan A, Khan S, Abdallah W. Challenges for extending the application of nanoparticles in high salinity reservoirs. Soc Pet Eng-SPE Kingdom Saudi Arab Annu Tech Symp Exhib 2016). Several types of nanoparticles such as metallic (e.g., Al₂O₃, CuO, Fe₂O₃/Fe₃O₄, N₂O, MgO, SnO₂, TiO₂, ZnO, ZrO₂), magnetic (e.g., CoFe₂O₄), organic (e.g., Carbon and CNT) and inorganic (e.g., SiO₂), have been employed in various forms to support drilling operations and boost the production of the unrecovered hydrocarbon resources in reservoirs (See: Muhammed N S, Olayiwola T, Elkatatny S, Haq B, Patil S. Journal of Natural Gas Science and Engineering Insights into the application of surfactants and nanomaterials as shale inhibitors for water-based drilling fluid: A review. J Nat Gas Sci Eng 2021 and Sun X, Zhang Y, Chen G, Gai Z. Application of nanoparticles in enhanced oil recovery: A critical review of recent progress).

A specific focus on inorganic nanoparticles such as silica has been described due to their occurrence nature and ease of functionalization (See: Abhishek R. Interaction of silica nanoparticles with chalk and sandstone minerals: Adsorption, fluid/rock interactions in the absence and presence of hydrocarbons. Stavanger University Library; 2020). Silica nanoparticles have received substantial attention as they are the most extensively studied nanomaterials, primarily due to their environmental friendliness and cost-effectiveness (See: Youssif M I, El-Maghraby R M, Saleh S M, Elgibaly A. Silica nanofluid flooding for enhanced oil recovery in sandstone rocks. Egypt J Pet 2018). A nano-emulsion is a biphasic dispersion of two immiscible liquids, involving either water in oil (W/O) or oil in water (O/W) droplets stabilized by nanoparticles, whereas the dispersion of nanoparticle-stabilized gas bubbles within a liquid is termed a nano foam. A nanofluid, however, is a colloidal dispersion of nanoparticles with different dispersing liquids, including polymer or surfactants. While some nanofluids are hydrophilic (water-dispersed), others are hydrophobic (oil-dispersed). The usage of this dispersed medium is dependent on the type of nanoparticle being applied.

Despite recent advances in oil recovery, there is still a need for a method for enhanced oil recovery that can effectively address the environmental challenges associated with current EOR practices, which significantly impact both oil recovery and the environment. Furthermore, the method should overcome the above problems at an affordable cost to ensure swift industrial adoption while maintaining simplicity.

In view of the foregoing, a cost-efficient and economically viable method for overcoming the drawbacks of the current state of the EOR procedures is described. One object of the present disclosure is to provide a method for green enhanced oil recovery from a hydrocarbon reservoir in a subterranean geologic formation. A second object of the present disclosure is to provide a method of making a nanofluid composition in EOR.

### SUMMARY

In an exemplary embodiment, a method for green enhanced oil recovery from a hydrocarbon reservoir in a subterranean geologic formation is disclosed. The method includes, injecting a nanofluid composition into the geologic formation via an injection well. In some embodiments, the geologic formation includes the injection well, a production well, and the hydrocarbon reservoir. Further, the hydrocarbon reservoir contains a hydrocarbon composition. In some embodiments, the interfacial tension (IFT) of the hydrocarbon composition, and the nanofluid composition is about 48% to 55% less than the IFT of the hydrocarbon composition and a brine as determined by the pendant drop method. In some embodiments, the nanofluid composition comprises silicon oxide (SiO₂) nanoparticles (NPs), and xanthan gum. Moreover, the method includes the preparation of SiO₂ NPs by ball milling red sand dune sand and collecting the hydrocarbon composition from the reservoir via the production well.

In some embodiments, the nanofluid composition includes about 0.05 weight percentage (wt. %) of SiO₂ NPs, about 0.08 wt. % to 0.16 wt. % of the xanthan gum, and about 3 wt. % of a water-soluble mineral. Each wt. % is based on a total weight of the nanofluid composition.

In some embodiments, the water-soluble mineral comprises one or more of sodium chloride, potassium chloride, calcium chloride, magnesium chloride, sodium bromide, and potassium bromide.

In some embodiments, the SiO₂ NPs have a uniform crystalline lattice structure and an average particle size of 8 to 250 nanometers (nm).

In some embodiments, the SiO₂ NPs present in the nanofluid composition are disposed on surfaces of particles of the xanthan gum.

In some embodiments, the xanthan gum has an average molecular weight in a range of 10,000 Daltons (Da) to 1,000,000 Da.

In some embodiments, the nanofluid composition is injected into the reservoir at an injection rate of about 0.25 cubic centimeters per minute (cm³/min) under a temperature of about 50 degree Celsius (° C.), and a pressure of about 1050 pounds per square inch (psi).

In some embodiments, the nanofluid composition has a zeta potential of −13 millivolts (mV) to −17 mV measured at about 25° C.

In some embodiment, the nanofluid composition has a pH of 5 to 6.

In some embodiments, the nanofluid composition has a viscosity of 1.000 milli pascal per second (mPa·s) to 1.020 mPa·s at a temperature of 20° C. to 25° C.

In some embodiments, the nanofluid composition further comprises one or more selected from the group consisting of a foaming agent, a gelling agent, a pH control agent, a breaker, an oxidizing breaker, a fluid loss control additive, a clay stabilizer, a corrosion inhibitor, a crosslinking agent, a scale inhibitor, a catalyst, a surfactant, a preservative, a biocide, a thermal stabilizer, and a combination thereof.

In some embodiments, the IFT of the hydrocarbon composition and the nanofluid composition is in a range of 9 to 10.5 dynes per centimeter (dynes/cm).

In some embodiments, the reservoir is at least one selected from the group consisting of a sandstone reservoir and a carbonate reservoir.

In some embodiments, the geological formation of the reservoir comprises a rock material selected from the group consisting of Bentheimer sandstone, Berea sandstone, Vosges sandstone, quartz, borosilicate glass, basalt, shale, calcite, granite, dolomite, gypsum, anhydrite, mica, kaolinite, illite, montmorillonite, and coal.

In some embodiments, the geological formation has a pore volume of about 27.5 cm³ to 28 cm³. In some embodiments, the geological formation has a porosity of 18% to 18.5% based on a total volume of the geological formation. In some embodiments, the geological formation has a permeability of 60 millidarcy (mD) to 80 mD.

In some embodiments, the hydrocarbon composition comprises Arab light crude oil.

In some embodiments, the method recovers 5% to 15% more of the original oil in place (OOIP) than a method in the absence of the injecting of the nanofluid composition.

In another exemplary embodiment, a method of preparing the nanofluid composition is described. The method includes ball-milling red sand dune sand with zirconium (Zr) balls having an average size (diameter) of 600 micrometers (μm) to 800 μm to form the SiO₂ NPs. The method further includes dispersing the SiO₂ NPs in an aqueous liquid containing a water-soluble mineral to form a dispersion and mixing the xanthan gum and the dispersion to form the nanofluid composition.

In some embodiments, a mass ratio of the red sand dune sand to the Zr balls during the ball-milling is about 20:1.

In some embodiments, the ball-milling is carried out at about 3000 revolutions per minute (rpm) for about 12 hours to 18 hours.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a flowchart depicting a method of green enhanced oil recovery from a hydrocarbon reservoir, according to certain embodiments;

FIG. 1B is a flowchart depicting a method of preparing nanofluid composition, according to certain embodiments;

FIG. 2 shows a schematic diagram depicting sequence of silicon dioxide (SiO₂) nanoparticles (NPs) production, according to certain embodiments;

FIG. 3 shows a schematic illustration of a core flooding setup, according to certain embodiments;

FIG. 4 shows a schematic block diagram depicting the process conditions involved in the core flooding, according to certain embodiments;

FIG. 5 shows an X-ray diffraction (XRD) pattern of the SiO₂ nanoparticles, according to certain embodiments;

FIG. 6A shows a transmission electron microscopy (TEM) image of the SiO₂ nanoparticles, according to certain embodiments;

FIGS. 6B-6C show high-resolution transmission electron microscopy (HRTEM) images of the SiO₂ nanoparticles, at different magnifications, according to certain embodiments;

FIG. 7 is a bar graph depicting the zeta potential values for nanofluid compositions including various concentrations of xanthan gum (XG), according to certain embodiments;

FIG. 8 shows a graph depicting the effect of the concentration of the XG, in the nanofluid composition (3 wt. % NaCl, 0.05 wt. % SiO₂, at varying XG concentrations), on interfacial tension (IFT), according to certain embodiments;

FIG. 9 depicts the effect of temperature on the viscosity of nanofluid compositions, according to certain embodiments;

FIG. 10 depicts the total oil recovery from the core after flooding with a first composition, according to certain embodiments;

FIG. 11 shows a graph depicting the total oil recovery from the core after flooding with a second composition, according to certain embodiments;

FIG. 12 is a graph comparing the total oil recovery observed from the first composition and the second composition, according to certain embodiments; and

FIG. 13 is a graph comparing the oil recovery with the first composition and the second composition, at secondary and tertiary flooding, according to certain embodiments.

### DETAILED DESCRIPTION

When describing the present disclosure, the terms used are to be construed in accordance with the following definitions, unless a context dictates otherwise. Embodiments of the present invention will now be described more fully hereinafter with reference to the accompanying drawings wherever applicable, in which some, but not all embodiments of the disclosure are shown.

Further, as used herein, the use of singular includes the plural and the words “a”, and “an” includes “one” and means “at least one” unless otherwise stated in this application.

As used herein, the words “about,” “approximately,” or “substantially similar” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), +/−15% of the stated value (or range of values), or +/−20% of the stated value (or range of values). Within the description of this disclosure, where a numerical limit or range is stated, the endpoints are included unless stated otherwise. Also, all values and subranges within a numerical limit or range are specifically included as if explicitly written out.

The use of the terms “include,” “includes”, “including,” “have,” “has,” or “having” should be generally understood as open-ended and non-limiting unless specifically stated otherwise.

The term “subterranean geologic formation” generally refers to any rock formation beneath the surface of the earth having a set of pre-determined and examined properties, including a production well, an injection well and a hydrocarbon reservoir.

As used herein, the terms “reservoir”, “oil reservoir” and “petroleum reservoir” refer to a component of a petroleum system (i.e., hydrocarbon or petroleum-generating and storing geologic system) that is composed of a subsurface body of rock formations having sufficient porosity and permeability to store and transmit fluids. Sedimentary rocks are the most common reservoir rocks because they have more porosity than most igneous and metamorphic rocks and form under temperature conditions at which hydrocarbons can be preserved. Depending on the type of sedimentary rock, reservoirs can be classified as carbonate reservoirs, having predominantly limestones, and sandstone reservoirs having primarily siliclastic rocks and clay. The reservoir may be, but is not limited to, a shale reservoir, a carbonate reservoir, a tight sandstone reservoir, a tight siltstone reservoir, a gas hydrate reservoir, a coalbed methane reservoir, etc. In general, carbonate reservoirs tend to have lower primary permeability and salinity compared to sandstone reservoirs.

As used herein, the term “permeability” refers to the ability, or measurement of a reservoir rock's ability, to transmit fluids and is typically measured in darcies (d) or millidarcies (md). Formations that transmit fluids readily, such as sandstones, are described as permeable and tend to have many large, well-connected pores. Impermeable formations tend to be finer-grained or of a mixed-grain size, with smaller, fewer, or less interconnected pores. As used herein, a “low-permeability reservoir” refers to an oil reservoir having a range of permeability that is no higher than 10 md, preferably 0.05-10 md, more preferably 0.1-7.5 md, even more preferably 0.5-5 md, most preferably 1-5 MD. Accordingly, as used herein, a “high-permeability reservoir” refers to an oil reservoir having a range of permeability that is higher than 10 MD.

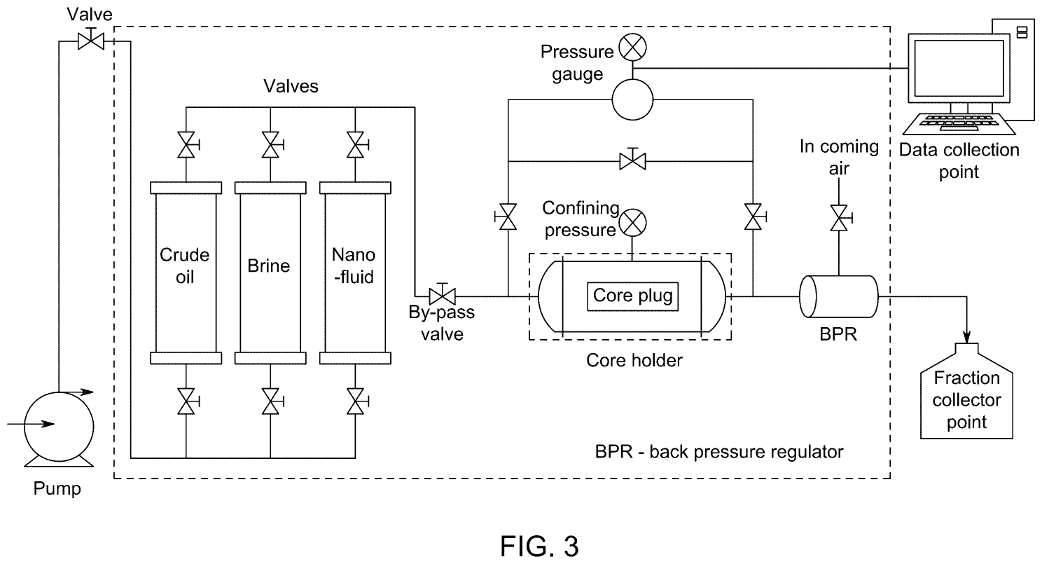

As used herein, the term “porosity” refers to the percentage or ratio of void space to the pore volume (PV) of a rock, or the total volume within the rock that can contain or hold fluids, which is typically no more than 20-25% for both sandstone and carbonate reservoirs. “Total porosity” is the total void space in the rock, whether or not it contributes to fluid flow. Thus, effective porosity is typically less than total porosity. In the present disclosure, the “porosity” of the geological formation, including a sandstone and/or a carbonate, may be determined by American Petroleum Institute recommended practices for core analysis (API RP 40, which is incorporated herein by reference in its entirety), which is also depicted in FIG. 3 of the present disclosure.

As used herein, the term “pore volume” refers to the total volume in a reservoir that can be occupied by fluids. This term is also used as a measurement unit referring to the amount of fluid, such as chemical fluid or water, that is injected into a reservoir during secondary and tertiary recoveries.

As used herein, the term “enhanced oil recovery,” “EOR” or “tertiary oil recovery” refers to a technique for increasing the amount of hydrocarbons that may be extracted from a “hydrocarbon-bearing formation” or “formation”. As used herein, the terms “hydrocarbon-bearing formation” or “formation” are generally used interchangeably and refer to a hydrocarbon-bearing formation in the field (e.g., subterranean hydrocarbon-bearing formations) and portions of such hydrocarbon-bearing formations (e.g., core samples).

As used herein, the term “fluid loss additive” generally refers to a material capable of reducing volume of a filtrate that passes through a filter medium.

As used herein, the term “shale stabilizer” generally refers to a chemical substance that can be added to a treatment fluid to reduce shale sloughing.

As used herein, the term “bridging agent” generally refers to a material or substance that, when present in a treatment fluid, can bridge across the pore throat or fractures of an exposed rock, thereby building a filter cake to prevent or reduce loss of the treatment fluid or a portion thereof to a subterranean formation.

As used herein, the term “weighting agent” generally refers to particulates used to modulate the density of a treatment fluid.

As used herein, the term “olefin sulfonate” generally refers to a surfactant derived from direct sulfonation of olefin. The olefin from which the olefin sulfonate is derived is a mono-olefin having about 12 to 24 carbon atoms, preferably about 14 to 16 carbon atoms.

As used herein, the term “solution” generally refers to its normal meaning, as understood by one skilled in the art, e.g., a homogeneous mixture of a solid dissolved in a liquid. However, as used herein, the term “solution” is not intended to be read as necessarily requiring the absence of other, non-dissolved materials, or a that the solution is the continuous phase of a mixture.

As used herein, the term “aqueous solution” generally refers to a liquid having a relatively high polarity and being substantially immiscible with oils.

Aspects of the present disclosure are directed to the use of a biopolymer modified with silica nanoparticles for oil recovery applications. The biopolymer is xanthan gum (XG). The XG was modified with silicon oxide (SiO₂) nanoparticles (NPs). The present disclosure provides a method of using SiO₂ NPs as a surface coating agent for XG biopolymer to modify the stability, carrying capacity, and recovery strength for enhanced oil recovery (EOR) applications.

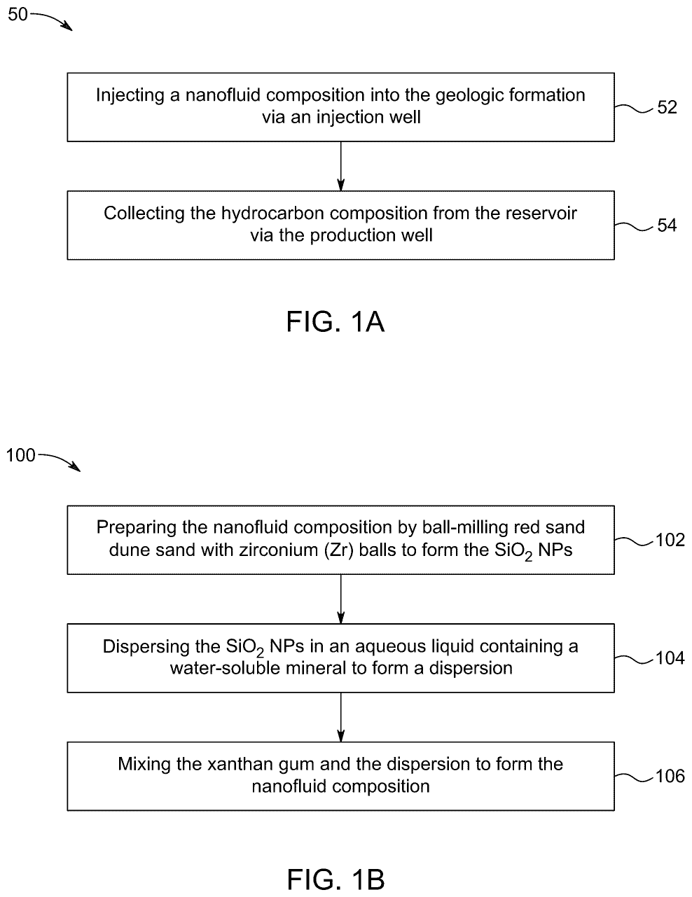

FIG. 1A illustrates a flow chart of a method 50 for green enhanced oil recovery in a hydrocarbon reservoir present in a geological formation. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes injecting a nanofluid composition (also interchangeably referred to as the nanofluid formulation) into the geologic formation via an injection well. The geological formation generally includes at least an injection well configured to place oil and gas production waste, such as brine, into a porous rock formation for storage. Generally, the injection well is drilled thousands of feet, preferably at least 1000 feet, preferably at least, 2000, 3000, 4000 or 5000 feet, preferably at least 10,000 feet, preferably at least 15,000 feet, or even more preferably at least 20,000 feet, into the earth to inject injection fluids into the porous rock formation. By injecting at depth, the injection well does not inject production waste into subsurface freshwater reservoirs. The production waste is further stored in the injection well during the oil and gas extraction process. The geological formation further includes at least one production well configured to extract oil or gas from the subsurface during the oil and gas extraction process. The production well is also drilled thousands of feet, preferably at least 1000 feet, preferably at least 2000, 3000, 4000 or 5000 feet, preferably at least 10,000 feet, preferably at least 15,000 feet, or even more preferably at least 20,000 feet, into the earth directly into oil or gas-rich deposits contained in underground formations.

The injection may be performed manually, or it may be automatic, for example, by using a chemical injection pump. In any of the above applications, the nanofluid composition including the SiO₂ NPs and xanthan gum, or any of its components combinable downhole may be injected continuously and/or in batches. The chemical injection pump(s) can be automatically or manually controlled to inject any amount of the nanofluid composition, needed for secondary and/or tertiary oil recovery operations.

Injection pressures and temperatures of the nanofluid composition may be kept constant or varied. In some embodiments, the injection pressure of the nanofluid composition, including, is up to 6,000 psi, preferably 25 to 6,000 psi, preferably 50 to 6,000 psi, preferably 100 to 5,750 psi, preferably 250 to 5500 psi. Other ranges are also possible.

During the oil and gas extraction process, hydraulic fracturing is used to aid in the release of hydrocarbons from the geologic matrix. Hydraulic fracturing is defined as a method in which a mixture of water, sand, and chemicals called “brine” is injected at high pressure through the injection well to fracture the rock, which then releases the oil or natural gas and allows it to flow to the ground surface. In some embodiments, the geological formation further includes a hydrocarbon-containing reservoir. The hydrocarbon reservoir contains a hydrocarbon composition. In some embodiments, the geological formation may further include at least one heat well configured to heat the geological formation containing the hydrocarbon composition. As used herein, the term “heat well” generally refers to a vertical pipe or casing that is used to circulate heated fluid, e.g., hot water or steam, into an oil reservoir. In the present disclosure, the heat well can heat geologic matrix and the hydrocarbon composition in the reservoir after injecting the nanofluid composition. The viscosity of the nanofluid composition, and the hydrocarbon composition may be reduced after the heating, making it easier to pump out of the well.

In some embodiments, the heat well is in the form of a closed-loop pipeline having an aboveground loop part, and an underground loop part. The aboveground loop part is in thermal communication with a heat pump supplied by at least one energy source selected from the group consisting of natural gas, electricity, diesel fuel, and solar energy. The heat pump may be monitored and controlled by a computer system to ensure that a desired temperature for the hydrocarbon composition in the geological formation is achieved. In some further embodiments, the underground loop part is extended into the central cavity of the geological formation and is in a helix shape that allows substantial contact with the nanofluid composition, and the hydrocarbon composition. In some more preferred embodiments, the underground loop part is in thermal communication with the nanofluid composition, and the hydrocarbon composition.

In yet some other embodiments, the underground loop part of the heat well may be located around the geological formation and is surrounded by layers of rock and soil. The underground loop part is drilled deep into the ground and is equipped with a series of perforations or slots, known as a perforated casing, that allow the heated fluid to flow into the surrounding rock and heat up the geological formation surrounded by the underground loop part.

In some embodiments, the geological formation may further include a natural gas storage space, a carbon sequestration reservoir, an aquifer, a geothermal reservoir, and an in-situ leachable ore deposit. In a preferred embodiment, the reservoir is at least one selected from the group consisting of a sandstone reservoir and a carbonate reservoir. In some embodiments, the geological formation includes a rock material obtained from at least one shale selected from the group consisting of Eagle ford shale, Wolfcamp shale, Posidonia shale, Wellington shale, and Mancos shale. The rock material includes one or more of Bentheimer sandstone, Berea sandstone, Vosges sandstone, quartz, borosilicate glass, basalt, shale, calcite, granite, dolomite, gypsum, anhydrite, mica, kaolinite, illite, montmorillonite, and coal.

In some embodiments, the geological formation has a pore volume of about 25 cm³ to 30 cm³, preferably 27.5 cm³ to 28 cm³, preferably 27.6, preferably 27.7, preferably 27.8 cm³. Other ranges are also possible.

In some embodiments, the geological formation has a porosity of 15% to 25%, preferably 18% to 20%, preferably 18% to 18.5%, preferably 18.01%, preferably 18.03%, preferably 18.05%, preferably 18.07%, preferably 18.09%, preferably 18.1%, preferably 18.13%, preferably 18.15%, preferably 18.17%, or even more preferably 18.19%, based on a total volume of the geological formation. Other ranges are also possible.

In some embodiments, the geological formation has a permeability of 30 mD to 100 mD, preferably 60 mD to 80 mD, preferably about 61, preferably about 62, preferably about 63, preferably about 64, preferably about 65, preferably about 66, preferably about 67, preferably about 68, preferably about 69, preferably about 70, preferably about 71, or even more preferably about 72 mD and all ranges in between. Other ranges are also possible.

In some embodiments, the hydrocarbon reservoir contains a hydrocarbon composition. As used herein the term “hydrocarbon mixture,” or “hydrocarbon composition” generally refers to a combination of different hydrocarbons, i.e., to a combination of various types of molecules that contain carbon atoms and, in many cases, attached hydrogen atoms. The “hydrocarbon composition” may comprise many different molecules having a wide range of molecular weights. In some embodiments, the hydrocarbon composition contains one or more aliphatic hydrocarbons having various length of carbon chains, different substituent groups, and different saturations; and one or more aromatic hydrocarbons having various length of carbon chains, different substituent groups, and different saturations.

In some embodiments, the interfacial tension (IFT) of the hydrocarbon composition and the nanofluid composition is preferably about 48%, about 49%, about 50%, about 51%, about 52%, about 53%, about 54%, and about 55% less than the IFT of the hydrocarbon composition and brine as determined by the pendant drop method, according to ASTM D1331-14 which is incorporated herein by reference in its entirety. Other ranges are also possible. In general, the pendant drop method is a scientific method used to determine the IFT of a fluid by using the curvature of the drop profile. The IFT of the hydrocarbon composition and the nanofluid composition is in a range of 5 dynes/cm to 20 dynes/cm, preferably 5 dynes/cm to 15 dynes/cm, or even more preferably 9 dynes/cm to 10.5 dynes/cm, as depicted in FIG. 8. Other ranges are also possible.

In some embodiments, the nanofluid composition includes silicon oxide (SiO₂) nanoparticles (NPs), and xanthan gum. In some embodiments, the SiO₂ NPs are prepared by ball-milling the sand of the red sand dunes, near Riyadh, Saudi Arabia. In a preferred embodiment, the nanofluid composition includes about 0.05 wt. % of SiO₂ NPs, about 0.08 wt. %, about 0.09 wt. %, about 0.10 wt. %, about 0.11 wt. %, about 0.12 wt. %, about 0.13 wt. %, about, 0.14 wt. %, about 0.15 wt. % but less than 0.16 wt. % of the xanthan gum.

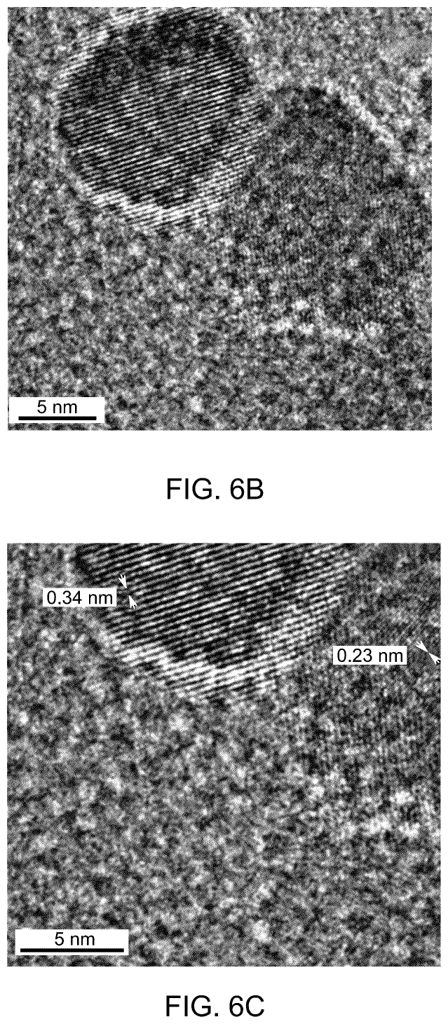

In some embodiments, the SiO₂ NPs have a uniform crystalline lattice structure and an average particle size of 5 to 500 nm, preferably 8 nm to 400 nm, preferably 11 nm to 300 nm, or even more preferably 14 nm to 200 nm, as depicted in FIGS. 6A to 6C. Other ranges are also possible. Further, the SiO₂ NPs present in the nanofluid composition are disposed on surfaces of particles of the xanthan gum, and the xanthan gum has an average molecular weight in a range of 10,000 Da to 1,000,000 Da, preferably 50,000 Da to 800,000 Da, preferably 100,000 Da to 600,000 Da, preferably 300,000 Da to 500,000 Da, or even more preferably about 400,000 Da. Other ranges are also possible. In some embodiments, at least 60%, at least 70%, at least 80%, at least 90%, or more preferably at least 99% of a total surface area of the particles of the xanthan gum is covered by the nanofluid composition. Other ranges are also possible.

The nanofluid composition further includes about 0.1 to 10 wt. %, preferably 1 to 8 wt. %, preferably 2 to 6 wt. %, preferably 3 to 4 wt. %, or even more preferably about 3 wt. % [of a water-soluble mineral, and each wt. % is based on the total weight of the nanofluid composition. In some embodiments, the water-soluble mineral includes one or more of sodium chloride, potassium chloride, calcium chloride, magnesium chloride, sodium bromide, and potassium bromide. In some embodiments, the nanofluid composition further includes one or more selected from the group consisting of a foaming agent, a gelling agent, a pH control agent, a breaker, an oxidizing breaker, a fluid loss control additive, a clay stabilizer, a corrosion inhibitor, a crosslinking agent, a scale inhibitor, a catalyst, a surfactant, a preservative, a biocide, a thermal stabilizer, and a combination thereof.

Typically, when present, the additive(s) may be incorporated in an amount of up to 5 wt. %, preferably up to 4 wt. %, preferably up to 3 wt. %, preferably up to 2 wt. %, preferably up to 1 wt. %, preferably up to 0.5 wt. %, preferably up to 0.1 wt. %, preferably up to 0.05 wt. %, preferably up to 0.01 wt. %, and/or ranges therebetween, based on a total weight of the nanofluid composition.

Additive(s) suitable for use in oil and gas well operations, and particularly during oil recovery operations, are known by those of ordinary skill in the art, and may include, but are not limited to, viscosity modifying agents e.g., bauxite, bentonite, dolomite, limestone, calcite, vaterite, aragonite, magnesite, taconite, gypsum, quartz, marble, hematite, limonite, magnetite, andesite, garnet, basalt, dacite, nesosilicates or orthosilicates, sorosilicates, cyclosilicates, inosilicates, phyllosilicates, tectosilicates, kaolins, montmorillonite, fullers earth, halloysite, polysaccharide gelling agents (e.g., xanthan gum, scleroglucan, and diutan) as well as synthetic gelling agents (e.g., polyacrylamides and co-polymers thereof, psyllium husk powder, hydroxyethyl cellulose, carboxymethylcellulose, and polyanionic cellulose, poly(diallyl amine), diallyl ketone, diallyl amine, styryl sulfonate, vinyl lactam, laponite.

The nanofluid composition may also optionally include one or more surfactants. The surfactant(s), when present, may be included in an amount of up to 5 wt. %, preferably up to 4 wt. %, preferably up to 3 wt. %, preferably up to 2 wt. %, preferably up to 1 wt. %, preferably up to 0.5 wt. %, preferably up to 0.1 wt. %, preferably up to 0.05 wt. %, preferably up to 0.01 wt. %, and/or ranges therebetween, based on a total weight of the nanofluid composition. Cationic, anionic, non-ionic, and/or amphoteric surfactants may be employed herein. Cationic surfactants may include, but are not limited to a protonated amine formed from a reaction between a C₆-C₂₆ alkyl amine compound and an acid (e.g., acetic acid, formic acid, propionic acid, butyric acid, pentanoic acid, hexanoic acid, oxalic acid, malonic acid, lactic acid, glyceric acid, glycolic acid, malic acid, citric acid, benzoic acid, p-toluenesulfonic acid, trifluoromethanesulfonic acid, hydrochloric acid, nitric acid, phosphoric acid, sulfuric acid, hydrobromic acid, perchloric acid, hydroiodic acid, etc.), such as protonated salts of C₆-C₂₆ alkyl monoamines, C₆-C₂₆ alkyl (poly)alkylene polyamines, and alkoxylated fatty amines; a protonated C₆-C₂₆ alkyl amidoamine formed from a reaction between a C₆-C₂₆ alkyl amidoamine compound and an acid (for example the acids listed above), such as protonated forms of the amide reaction product between any fatty acid (or ester derivative thereof) with a polyamine (e.g., putrescine, cadaverine, ethylene diamine, N1,N1-dimethylethane-1,2-diamine, N1,N1-dimethylpropan-1,3-diamine, N1,N1-diethylethane-1,2-diamine, N1,N1-diethylpropane-1,3-diamine, spermidine, 1,1,1-tris(aminomethyl) ethane, tris(2-aminoethyl)amine, spermine, TEPA, DETA, TETA, AEEA, PEHA. HEHA, dipropylene triamine, tripropylene tetramine, tetrapropylene pentamine, pentapropylene hexamine, hexapropylene heptamine, dibutylene triamine, tributylene tetramine, tetrabutylene pentamine, pentabutylene hexamine, hexabutylene heptamine), with specific mention being made to protonated forms of stearamidopropyldimethylamine, stearamidopropyldiethylamine, stearamidoethyldiethylamine, stearamidoethyldimethylamine, palmitamidopropyl dimethylamine, palmitamidopropyl diethylamine, palmitamidoethyl diethylamine, palmitamidoethyldimethylamine, behenamidopropyl dimethylamine, behenamidopropyl behenamidoethyl diethylamine, behenamidoethyl dimethylamine, diethylmine, arachidamidopropyl dimethylamine, arachidamidopropyl diethylamine, arachidamidoethyl diethylamine, and arachidamidoethyl dimethylamine; and a quaternary ammonium compound made from alkylation with suitable alkylating agents (e.g., dimethyl sulfate, methyl chloride or bromide, benzyl chloride or bromide, C₆-C₂₆ alkyl chloride or bromide, etc.) of a tertiary C₆-C₂₆ alkyl amine, an alkoxylated (tertiary)amine, or an aprotic nitrogenous heteroarene (optionally substituted) having at least one aromatic nitrogen atom with a reactive lone pair of electrons, with specific mention being made to a tri-fatty alkyl lower alkyl ammonium compound (e.g., trioctyl methyl ammonium chloride), a C₁₀-C₁₈ alkyl trimethyl ammonium chloride or methosulfate, a di-C₁₀-C₁₈ alkyl dimethyl ammonium chloride or methesulfate, a C₁₀-C₁₈ alkyl benzyl dimethyl ammonium chloride, a methyl quaternized C₆-C₂₂ alkyl propylene diamine, a methyl quaternized C₆-C₂₂ alkyl propylene triamine, a methyl quaternized C₆-C₂₂ alkyl propylene tetraamine, a N-substituted C₁₀-C₁₈ alkyl pyridinium or a quinolinium bromide or chloride such as N-octyl pyridinium bromide, N-nonyl pyridinium bromide, N-decyl pyridinium bromide, N-dodecyl pyridinium bromide, N-tetradecyl pyridinium bromide, N-dodecyl pyridinium chloride, N-cyclohexyl pyridinium bromide, naphthyl methyl quinolinium chloride, naphthyl methyl pyridinium chloride, and cetylpyridinium chloride as well as mixtures thereof. Anionic surfactants may include, but are not limited to sulfates, such as alkyl sulfates, alkyl-ester-sulfates, alkyl ether sulfates, alkyl-alkoxy-ester-sulfate, sulfated alkanolamides, glyceride sulfates, in particular, sulfates of fatty alcohols or polyoxyalkylene ethers of fatty alcohols such as sodium dodecyl sulfate, sodium laureth sulfate, ammonium lauryl sulfate, potassium lauryl sulfate, sodium myreth sulfate; sulfonates such as alkyl sulfonates, fatty alkyl-benzene sulfonates, lower alkyl-benzene sulfonates, alpha olefin sulfonates, lignosulfonates, sulfo-carboxylic compounds, for example, dodecyl benzene sulfonate, dioctyl sodium sulfosuccinate, perfluorooctanesulfonate (PFOS), perfluorobutanesulfonate; phosphates such as alkyl acyl ether phosphates, alkyl ether phosphates, phosphates of fatty alcohols or polyoxyalkylene ethers of fatty alcohols such as cetyl phosphate salts, dicetyl phosphate salts, ceteth-10-phosphate salts; carboxylate salts of fatty acids, acylamino acids, lactylates, and/or fatty alcohols/polyoxyalkylene ethers of fatty alcohols such as sodium stearate, vegetable oil-based anionic surfactants (e.g., palm oil anionic surfactant), sodium behenoyl lactylate, sodium isostearoyl lactylate, sodium caproyl lactylate, sodium laureth-5 carboxylate, sodium laureth-6 carboxylate, sodium laureth-11 carboxylate; and mixtures thereof.

Non-ionic surfactants may include, but are not limited to amides or alkanolamides of fatty acids, that is, amide reaction products between a fatty acid and an amine or alkanolamine compound, such as coconut fatty acid monoethanolamide (e.g., N-methyl coco fatty ethanol amide), coconut fatty acid diethanolamide, oleic acid diethanolamide, palm based oleylamine, and vegetable oil fatty acid diethanolamide; alkoxylated alkanolamides of fatty acids, preferably ethoxylated and/or propoxylated variants of the alkanolamides of fatty acids using for example anywhere from 2 to 30 EO and/or PO molar equivalents, preferably 3 to 15 EO and/or PO molar equivalents, preferably 4 to 10 EO and/or PO molar equivalents, preferably 5 to 8 EO and/or PO molar equivalents per moles of the alkanolamide of the fatty acid (e.g., coconut fatty acid monoethanolamide with 4 moles of ethylene oxide); amine oxides, such as N-cocoamidopropyl dimethyl amine oxide and dimethyl C₆-C₂₂ alkyl amine oxide (e.g., dimethyl coco amine oxide); fatty esters, such as ethoxylated and/or propoxylated fatty acids (e.g., castor oil with 2 to 40 moles of ethylene oxide), alkoxylated glycerides (e.g., PEG-24 glyceryl monostearate), glycol esters and derivatives, monoglycerides, polyglyceryl esters, esters of polyalcohols, and sorbitan/sorbitol esters; ethers, such as (i) alkoxylated C₁-C₂₂ alkanols, which may include alkoxylated C₁-C₅ alkanols, preferably ethoxylated or propoxylated C₁-C₅ alkanols (e.g., dipropylene glycol n-butyl ether, tripropylene glycol n-butyl ether, dipropylene glycol methyl ether, tripropylene glycol methyl ether, diethylene glycol n-butyl ether, triethylene glycol n-butyl ether, diethylene glycol methyl ether, triethylene glycol methyl ether) and alkoxylated C₆-C₂₆ alkanols (including alkoxylated fatty alcohols), preferably alkoxylated C₇-C₂₂ alkanols, more preferably alkoxylated C₈-C₁₄ alkanols, preferably ethoxylated or propoxylated (e.g., cetyl stearyl alcohol with 2 to 40 moles of ethylene oxide, lauric alcohol with 2 to 40 moles of ethylene oxide, oleic alcohol with 2 to 40 moles of ethylene oxide, ethoxylated lanoline derivatives, laureth-3, ceteareth-6, ceteareth-11, ceteareth-15, ceteareth-16, ceteareth-17, ceteareth-18, ceteareth-20, ceteareth-23, ceteareth-25, ceteareth-27, ceteareth-28, ceteareth-30, isoceteth-20, laureth-9/myreth-9, and PPG-3 caprylyl ether); (ii) alkoxylated polysiloxanes; (iii) ethylene oxide/propylene oxide copolymers (e.g., PPG-1-PEG-9-lauryl glycol ether, PPG-12-buteth-16, PPG-3-buteth-5, PPG-5-buteth-7, PPG-7-buteth-10, PPG-9-buteth-12, PPG-12-buteth-16, PPG-15-buteth-20, PPG-20-buteth-30, PPG-28-buteth-35, and PPG-33-buteth-45); and (iv) alkoxylated alkylphenols; alkyl polyglycosides (APGs) such as those made from reaction between fatty alcohols and glucose; and mixtures thereof.

Amphoteric surfactants may include, but are not limited to C₆-C₂₂ alkyl dialkyl betaines, such as fatty dimethyl betaines (R—N(CH₃)₂(⁺)—CH₂COO—), obtained from a C₆-C₂₂ alkyl dimethyl amine which is reacted with a monohaloacetate salt (e.g., sodium monochloroacetate), such as C₁₂-C₁₄ dimethyl betaine (carboxylate methyl C₁₂-C₁₄ alkyl dimethylammonium); C₆-C₂₂ alkyl amido betaines (R—CO—NH—CH₂CH₂CH₂—N(CH₃)₂(⁺)—CH₂COO— or R—CO—NH—CH₂CH₂—N(CH₃)₂(⁺)—CH₂COO—), obtained by the reaction of a monohaloacetate salt (e.g., sodium monochloroacetate) with the reaction product of either dimethyl amino propylamine or dimethyl amino ethylamine with a suitable carboxylic acid or ester derivatives thereof, such as C₁₀-C₁₈ amidopropyl dimethylamino betaine; C₆-C₂₂ alkyl sultaines or C₆-C₂₂ alkyl amido sultaines, which are similar to those C₆-C₂₂ alkyl dialkyl betaines or C₆-C₂₂ alkyl amido betaines described above except in which the carboxylic group has been substituted by a sulfonic group (R—N(CH₃)₂(⁺)—CH₂CH₂CH₂SO₃— or R—CO—NH—CH₂CH₂CH₂—N(CH₃)₂(⁺)—CH₂CH₂CH₂SO₃— or R—CO—NH—CH₂CH₂—N(CH₃)₂(⁺)—CH₂CH₂CH₂SO₃—) or a hydroxysulfonic group (R—N(CH₃)₂(⁺)—CH₂CH(OH)—CH₂SO₃— or R—CO—NH—CH₂CH₂CH₂—N(CH₃)₂(⁺)—CH₂CH(OH)—CH₂SO₃—or R—CO—NH—CH₂CH₂—N(CH₃)₂(⁺)—CH₂CH(OH)—CH₂SO₃—), such as C₁₀-C₁₈ dimethyl hydroxysultaine and C₁₀-C₁₈ amido propyl dimethylamino hydroxysultaine; and mixtures thereof.

Suitable examples of chelating agents useful as sequestration agents of metal ions include, but are not limited to, iron control agents, such as ethylene diamine tetra acetic acid (EDTA), diethylene triamine pentaacetic acid (DPTA), hydroxyethylene diamine triacetic acid (HEDTA), ethylene diamine di-ortho-hydroxy-phenyl acetic acid (EDDHA), ethylene diamine di-ortho-hydroxy-para-methyl phenyl acetic acid (EDDHMA), and ethylene diamine di-ortho-hydroxy-para-carboxy-phenyl acetic acid (EDDCHA). Suitable examples of gel stabilizers/stabilizing agents include, but are not limited to, polypropylene glycol, polyethylene glycol, carboxymethyl cellulose, hydroxyethyl cellulose, polysiloxane polyalkyl polyether copolymers, acrylic copolymers, alkali metal alginates and other water-soluble alginates, carboxy vinyl polymers, ppolyvinylpyrrolidone and polyacrylates.

Suitable examples of dispersing agents include, but are not limited to, polymeric or co-polymeric compounds of polyacrylic acid, polyacrylic acid/maleic acid copolymers, styrene/maleic anhydride copolymers, polymethacrylic acid and polyaspartic acid. Suitable examples of corrosion inhibitors include, but are not limited to, alkoxylated fatty amines, chromates, zinc salts, (poly)phosphates, organic phosphorus compounds (phosphonates), acetylenic alcohols such as propargylic alcohol, α,β-unsaturated aldehydes such as cinnameldehyde and crotonaldehyde, aromatic aldehydes such as furfural, p-anisaldehyde, phenones including alkenyl phenones such as phenyl vinyl ketone, nitrogen-containing heterocycles such as imidazolines, piperazines, hexamethylene tetramines, quaternized heteroarenes such as 1-(benzyl) quinolinium chloride, and condensation products of carbonyls and amines such as Schiff bases.

Suitable examples of scale inhibitors include, but are not limited to, sodium hexametaphosphate, sodium tripolyphosphate, hydroxy ethylidene diphosphonic acid, aminotris(methylenephosphonic acid (ATMP), vinyl sulfonic acid, allyl sulfonic acid, polycarboxylic acid polymers such as polymers containing 3-allyloxy-2-hydroxy-propionic acid monomers, sulfonated polymers such as vinyl monomers having a sulfonic acid group, polyacrylates and co-polymers thereof.

Suitable examples of defoaming agents include, but are not limited to, silicone oils, silicone oil emulsions, organic defoamers, emulsions of organic defoamers, silicone-organic emulsions, silicone-glycol compounds, silicone/silica adducts, emulsions of silicone/silica adduct. Suitable examples of emulsifiers include, but are not limited to, a tallow amine, a ditallow amine, or combinations thereof, for example, a 50% concentration of a mixture of tallow alkyl amine acetates, C16-C18 (CAS 61790-60) and ditallow alkyl amine acetates (CAS 71011-03-5) in a suitable solvent such as heavy aromatic naphtha and ethylene glycol; as well as mixtures thereof.

In some embodiments, a biocide may be used. The biocide is an additive that may kill microorganisms present in the drilling fluid composition. Biocides suitable for use may be oxidizing or non-oxidizing biocides. Oxidizing biocides can include, but are not limited to, bleach, chlorine, bromine, chlorine dioxide, peroxycarboxylic acid, peroxycarboxylic acid composition, and materials capable of releasing chlorine, bromine, or peroxide. Non-oxidizing biocides include, but are not limited to, glutaraldehyde, isothiazolin, 2,2-dibromo-3-nitrilopropionamide, 2-bromo-1-bromo-1-(bromomethyl)-1,3-propanedicarbonitrile, 2-nitropropane-1,3 diol, tetrachloroisophthalonitrile, alkyldimethylbenzylammonium chloride, dimethyl dialkyl ammonium chloride, didecyl dimethyl ammonium chloride, poly(oxyethylene (dimethyliminio)ethylene (dimethyliminio)ethylene dichloride, methylene bisthiocyanate, 2-decylthioethanamine, tetrakishydroxymethyl phosphonium sulfate, dithiocarbamate, cyanodithioimidocarbonate, 2-methyl-5-nitroimidazole-1-ethanol, 2-(2-bromo-2-nitroethenyl) furan, beta-bromo-beta-nitrostyrene, beta-nitrostyrene, beta-nitrovinyl furan, 2-bromo-2-bromomethyl glutaronitrile, bis(trichloromethyl) sulfone, S-(2-hydroxypropyl)thiomethanesulfonate, tetrahydro-3,5-dimethyl-2H-1,3,5-hydrazine-2-thione, 2-(thiocyanomethylthio) benzothiazole, 2-bromo-4′-hydroxyacetophenone, 1,4-bis(bromoacetoxy)-2-butene, bis(tributyltin) oxide, 2-(tert-butylamino)-4-chloro-6-(ethylamino)-s-triazine, dodecylguanidine acetate, dodecylguanidine hydrochloride, coco alkyldimethylamine oxide, n-coco alkyltrimethylenediamine, tetra-alkyl phosphonium chloride, 7-oxabicyclo(2.2.1) heptane-2,3-dicarboxylic acid, 4,5-dichloro-2-n-octyl-4-isothiazoline-3-one, 5-chloro-2-methyl-4-isothiazolin-3-one, and 2-methyl-4-isothiazolin-3-one.

Suitable non-oxidizing biocides also include, for example, aldehydes (e.g., formaldehyde, glutaraldehyde, and acrolein), amine-type compounds (e.g., quaternary amine compounds and cocodiamine), halogenated compounds (e.g., 2-bromo-2-nitropropane-3-diol (Bronopol) and 2-2-dibromo-3-nitrilopropionamide (DBNPA)), sulfur compounds (e.g., isothiazolone, carbamates, and metronidazole), and quaternary phosphonium salts (e.g., tetrakis(hydroxymethyl)-phosphonium sulfate (THPS)).

Suitable oxidizing biocides include, for example, sodium hypochlorite, trichloroisocyanuric acids, dichloroisocyanuric acid, calcium hypochlorite, lithium hypochlorite, chlorinated hydantoins, stabilized sodium hypobromite, activated sodium bromide, brominated hydantoins, chlorine dioxide, ozone, peroxycarboxylic acid, peroxycarboxylic acid composition, and peroxides.

In some embodiments, the nanofluid composition is substantially free of an additive (e.g., viscosity modifying agent, a chelating agent, a stabilizing agent, a dispersing agent, a corrosion inhibitor, a scale inhibitor, a stabilizing agent, a defoaming agent, and an emulsifier).

The nanofluid composition, including the SiO₂ NPs and xanthan gum, and any optional additives may be added using any addition/dosing/mixing techniques known by those of ordinary skill in the art, including both manual and automatic addition techniques. For example, the addition may be carried out by using inline static mixers, inline mixers with velocity gradient control, inline mechanical mixers with variable speed impellers, inline jet mixers, motorized mixers, batch equipment, and appropriate chemical injection pumps and/or metering systems.

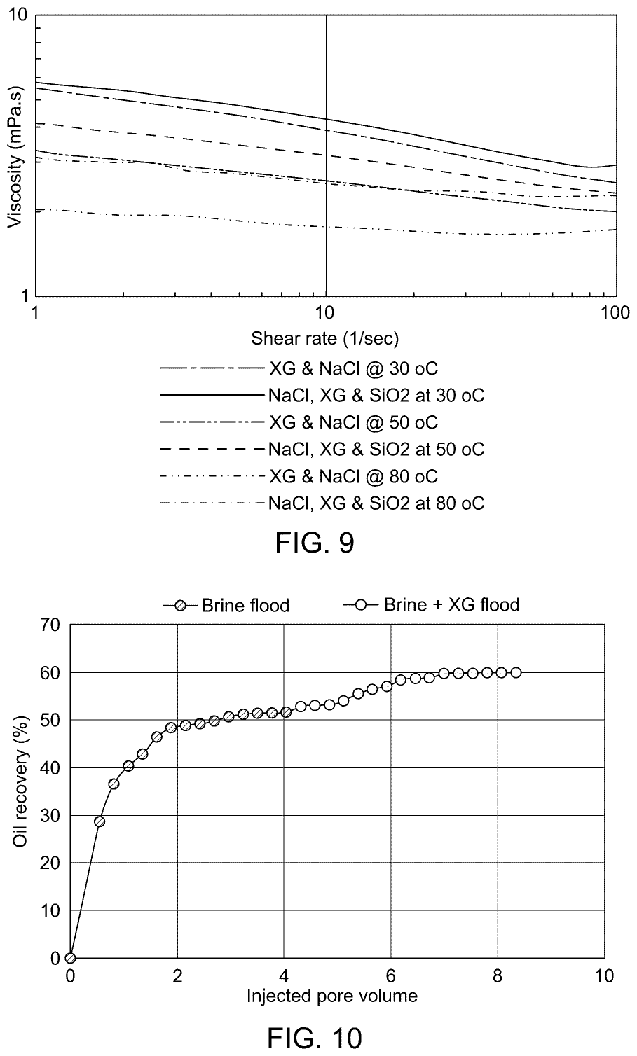

In some embodiments, the pH of the nanofluid composition is preferably between 4 to 8, preferably 5 to 7, or even more preferably 5 to 6. In some embodiments, the nanofluid composition has a viscosity of 1.000 to 1.100, preferably 1.005 to 1.080, preferably 1.010 to 1.060, or even more preferably 1.020 to 1.040 mPa·s at a temperature of 20° C. to 25° C., as depicted in FIG. 9. Other ranges are also possible.

In some embodiments, the nanofluid composition is injected into the reservoir at an injection rate of about 0.1 to 1.0 cm³/min, preferably about 0.15 to 0.8 cm³/min, preferably about 0.2 to 0.4 cm³/min, or even more preferably about 0.25 cm³/min under a temperature of about 50° C. and a pressure of about 800 to 1500 psi, or even more preferably about 1050 psi. In some other embodiments, the nanofluid composition is injected into the reservoir at an injection rate of at least 1.0 cm³/min, preferably at least 5.0 cm³/min, preferably 10.0 cm³/min, or even more preferably at least 50 cm³/min under a temperature of about 50° C. and a pressure of about 800 to 1500 psi, or even more preferably about 1050 psi. Other ranges are also possible.

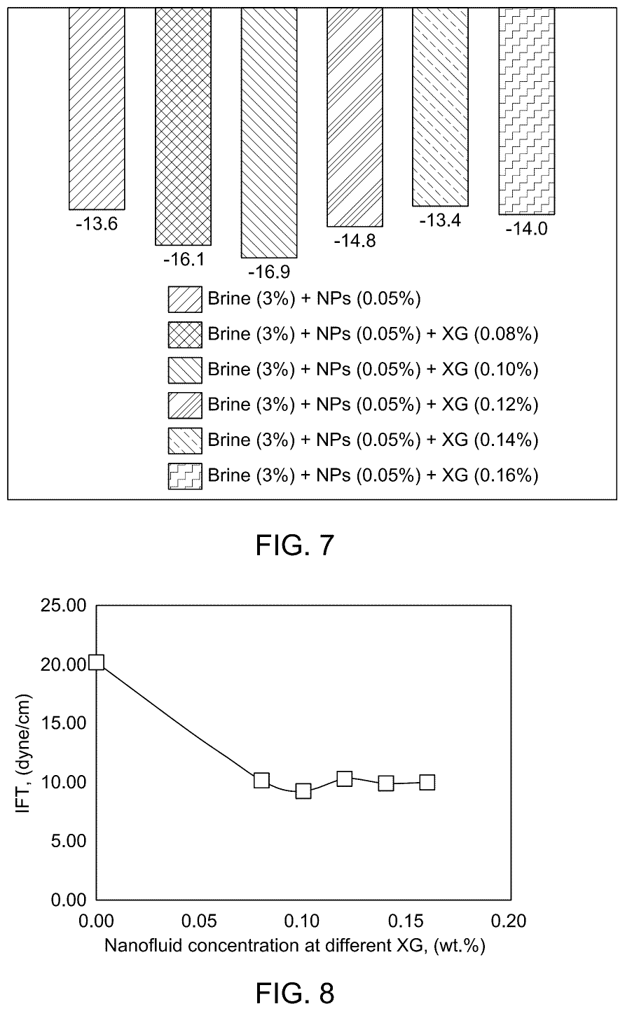

In some embodiments, the nanofluid composition has a zeta potential of −10 mV to −30 mV, preferably −11 mV to −20 mV, or even more preferably −13 mV to −17 mV measured at about 25° C., as depicted in FIG. 7. Other ranges are also possible.

At step 54, the method 50 includes collecting the hydrocarbon composition from the hydrocarbon reservoir via the production well. The hydrocarbon composition may include crude oil. After the injecting, the hydrocarbon composition (e.g., crude oil) and nanofluid composition mixture brought to the surface may then be separated using techniques known to those of ordinary skill in the art into respective aqueous and oil phases for further processing (e.g., crude oil refining/upgrading/processing). For example, the oil/nanofluid mixture may be separated at a fluids processing facility using emulsion breakers, water clarifiers, and/or other oil/water separation techniques known to those of ordinary skill in the art, such as by using gravity oil separators (API separators), plate separators or coalescing plate separators, separatory funnels, settling tanks, centrifugal separation (e.g., centrifugal water-oil separators, centrifugal settling devices, dewatering centrifuges), decanters, induced gas floatation such using microbubble technology, and skimming equipment.

The crude oil may be a very light crude oil such as Arab Extra Light, Arab Super Light, or Arab Super Light Ardjuna crude oil (e.g., a jet fuel, gasoline, kerosene, petroleum ether, petroleum spirit, or petroleum naphtha crude oil), a light crude oil such as Arab Light or Arab Light/Seg 17 Blend crude oil (e.g., grade 1 and grade 2 fuel oil, diesel fuel oil, domestic fuel oil), a medium crude oil such as Arab Medium crude oil, and a heavy crude oil such as Arab Heavy crude oil (e.g., grade 3, 4, 5, and 6 fuel oil, heavy marine fuel). Both sweet (sulfur volume lower than 0.50%) and sour (sulfur volume higher than 0.50%) crude oils may be displaced and recovered/collected according to the methods herein.

In preferred embodiments, the crude oil is a light or medium crude oil, preferably a light crude oil, preferably Arabian Light crude oil, preferably Arabian Light crude oil having a density at 25° C. of 0.81 to 0.83 g/mL, preferably 0.815 to 0.8298 g/mL, preferably 0.82 to 0.8296 g/mL, preferably 0.822 to 0.8294 g/mL, preferably 0.824 to 0.829 g/mL, preferably 0.826 to 0.8288 g/mL, preferably 0.828 to 0.8286 g/mL.

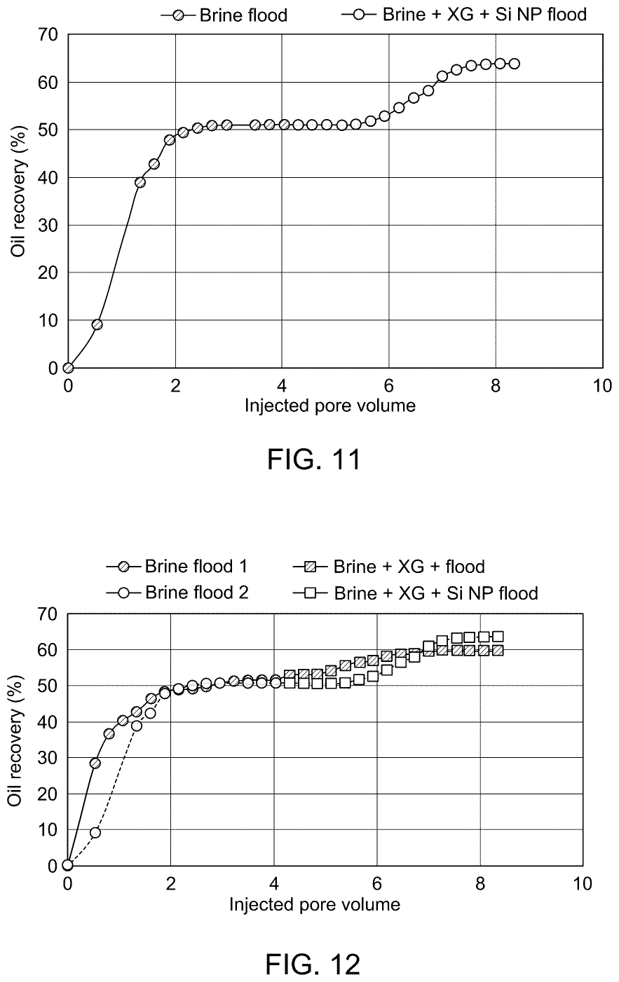

In some embodiments, the hydrocarbon composition may include Arab light crude oil. The method 50 recovers 1% to 30%, preferably 3% to 25%, preferably 5 to 20%, or even more preferably 5% to 15% more of the original oil in place (OOIP) than a method in the absence of the injecting of the nanofluid composition, as depicted in FIGS. 11 to 13. Other ranges are also possible.

Referring to FIG. 1B, a flowchart of a method 100 of preparing the nanofluid composition by ball milling is illustrated, according to certain embodiments. The order in which the method 100 is described is not intended to be construed as a limitation, and any number of the described method steps can be combined in any order to implement the method 100. Additionally, individual steps may be removed or skipped from the method 100 without departing from the spirit and scope of the present disclosure.

At step 102, the method 100 includes ball-milling red sand dune sand with zirconium (Zr) balls having an average size (diameter) of preferably 600 μm, preferably 650 μm, preferably 700 μm, preferably 750 μm but less than 800 μm to form the SiO₂ NPs. Zirconium balls were used owing to their smooth surface, good sphericity, and high grinding strength. In some embodiments, the mass ratio of the red sand dune sand to the Zr balls during the ball-milling is about 50:1, preferably 40:1, preferably 30:1, preferably 20:1, or even more preferably 10:1. Other ranges are also possible. In some embodiments, the ball-milling is carried out at about 3000 rpm for about 12 hours, about 13 hours, about 14 hours, about 15 hours, about 15 hours, about 17 hours, but less than 18 hours. Other ranges are also possible.

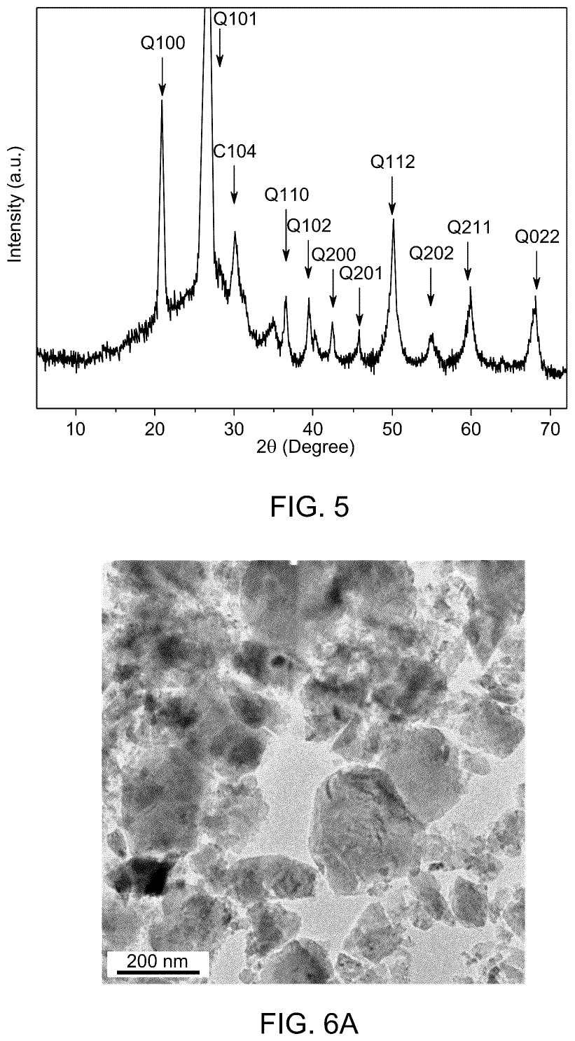

The crystalline structures of the SiO₂ NPs may be characterized by X-ray diffraction (XRD). In some embodiments, the XRD may be a wide-angle XRD. The XRD patterns are collected in a Rigaku Ultima IV diffractometer equipped with a Cu-Kα radiation source (λ=0.15406 nm) for a 2θ range extending between 5 and 80°, preferably 15 and 70°, further preferably 30 and 60° at an angular rate of 0.005 to 0.04° s⁻¹, preferably 0.01 to 0.03° s⁻¹, or even preferably 0.02° s⁻¹. In some embodiments, the SiO₂ NPs has at least a first intense peak with a 2 theta (θ) value in a range of 15 to 25°, preferably about 22°; at least a second intense peak with a 2θ value in a range of 25 to 30°, preferably about 25.5 to 28°; at least a third intense peak with a 2θ value in a range of 30 to 45°, preferably about 35 to 40°; at least a fourth intense peak with a 2θ value in a range of 45 to 50°, preferably about 50°; at least a fifth intense peak with a 2θ value in a range of 50 to 65°, preferably about 55 to 60°; and at least a sixth intense peak with a 2θ value in a range of 60 to 70°, preferably about 67°, as depicted in FIG. 5. Other ranges are also possible.

At step 104, the method 100 includes dispersing the SiO₂ NPs in an aqueous liquid containing a water-soluble mineral to form a dispersion. In some embodiments, the water-soluble mineral includes one or more of sodium chloride, potassium chloride, calcium chloride, magnesium chloride, sodium bromide, and potassium bromide. In a preferred embodiment, the water-soluble mineral is brine or NaCl. The concentration of the water-soluble mineral, preferably NaCl, is in the range of 1-5 wt. %, preferably 2 wt. %, preferably 3 wt. %, preferably 4 wt. %, preferably 5 wt. %. Other ranges are also possible.

At step 106, the method 100 includes mixing the xanthan gum and the dispersion to form the nanofluid composition. In some embodiments, the xanthan gum has an average molecular weight in a range of 10,000 Da to 1,000,000 Da, preferably 50,000 Da to 800,000 Da, preferably 100,000 Da to 600,000 Da, preferably 300,000 Da to 500,000 Da, or even more preferably about 400,000 Da. Other ranges are also possible. The concentration of the xanthan gum in the dispersion is in the range of 0.08-0.16 wt. %, preferably 0.08, 0.09, 0.1, 0.11, 0.12, 0.13, 0.14, 0.15, and 0.16 wt. %. In an embodiment, the xanthan gum and the dispersion are thoroughly stirred to ensure uniform mixing, preferably with a stirrer. The stirring is carried out at 1-3 hours, preferably 1.5-2 hours, preferably 2 hours, at 500-1000 rpm, preferably 600, 650, 700, 750, 800, 850, 900, 950, 1000 rpm at 25-35° C., preferably 26, 27, 28, 29, 30° C., or 34, 33, 32, 31, 30° C. Other ranges are also possible.

According to the present disclosure, the xanthan gum biopolymer demonstrated enhanced performance in the presence of SiO₂ nanoparticles, resulting in a substantial increase in residual oil recovery compared to formulations lacking silica NPs, thus, the method detailed in this disclosure offers a cost-effective solution with significant greenhouse gas emissions reduction in comparison to conventional enhanced oil recovery processes.

### EXAMPLES

The following examples demonstrate a method for green enhanced oil recovery from a hydrocarbon reservoir in a subterranean geologic formation as described herein. The examples are provided solely for illustration and are not to be construed as limitations of the present disclosure, as many variations thereof are possible without departing from the spirit and scope of the present disclosure.

### Example 1: Materials

The xanthan gum (XG) biopolymer and sodium chloride (NaCl) of 99.9% purity was purchased from Sigma Aldrich. SiO₂ nanoparticles (NPs) used for this experiment are prepared according to Example 2 of the present disclosure. These materials were prepared using deionized water (DI) purified by Elix 3 purification system (Millipore, USA). Arab light crude oil was used for this study.

### Example 2: Preparation and Characterization of SiO₂ Nanoparticles

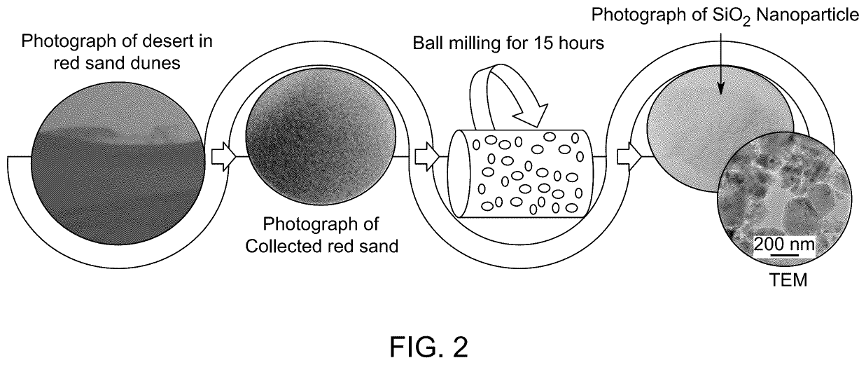

The sand was collected from a desert in Red Sand Dunes near Riyadh, Saudi Arabia. To obtain the sand NPs, a high-energy ball-milling technique was used (See: Haq B, Aziz M A, Al Shehri D, Muhammed N S, Basha S I, Hakeem A S, et al. Date-Leaf Carbon Particles for Green Enhanced Oil Recovery. Nanomaterials 2022; 12:1245, which is incorporated herein by reference in its entirety). The ball-milling process was run at 3000 rpm for 15 hours using Zirconium (Zr) balls of 600 to 800 μm size. Within the process, the applied ratio of the mass of Zr to sand material was about 1:20. The schematic for the entire procedure is described in FIG. 2. The prepared SiO₂ NPs were characterized by X-ray diffraction (XRD) (Rigaku Ultima IV diffractometer equipped with Cu-Kα radiation, Japan), and transmission electron microscopy (TEM) (JEM-2011; JEOL, Tokyo, Japan).

### Example 3: Nanofluid Formulation

A SiO₂ nanoparticle (0.05 wt. %) was suspended in an aqueous NaCl solution of 3 wt. % (30,000 ppm) in DI water. The brine has a density, viscosity, and pH of 1.0163 g/cm³, 1.001 cp, and 6.17, respectively. The density, viscosity, and pH were measured using a density meter (DMA-35), Cambridge piston-style viscometer, and Benchtop pH meter kits, respectively. This brine concentration was used as the water dispersant due to its high presence in the reservoir (See: Hendraningrat L, Li S, Torsæter O. A coreflood investigation of nanofluid enhanced oil recovery. J Pet Sci Eng 2013). XG biopolymer of different concentrations, 0.08 wt. %, 0.10 wt. %, 0.12 wt. %, 0.14 wt. %, and 0.16 wt. % was prepared and stirred for about 2 hours at 700 rpm and 30° C. using a magnetic stirrer. Each mixture was mixed thoroughly to avoid NPs precipitation and the XG suspension to ensure the homogeneity and stability of the solutions. A summary of the fluid properties is presented in Table 1.

TABLE 1
Fluid properties used for the experiment.

| | Density | | Viscosity | Temperature |
|---|---|---|---|---|
| Samples | (g/cm³) | pH | (mPa · s) | (° C.) |
| Brine (3 wt. %) | 1.0163 | 6.17 | 1.001 | 22.4 |
| Nanofluid at 0.08 wt. % XG | 1.0034 | 5.95 | 1.004 | 22.9 |
| Nanofluid at 0.10 wt. % XG | 1.0041 | 5.46 | 1.007 | 23.5 |
| Nanofluid at 0.12 wt. % XG | 1.0042 | 5.58 | 1.008 | 23.1 |
| Nanofluid at 0.14 wt. % XG | 1.0043 | 5.32 | 1.010 | 22.8 |
| Nanofluid at 0.16 wt. % XG | 1.0045 | 5.40 | 1.014 | 22.9 |
| Crude oil (Arab light) | 0.8707 | | 6.10 | 22.6 |

### Example 4: Zeta Potential Measurement

The Anton Paar Litesizer 500 (Graz, Austria) instrument was used to measure the zeta (ζ) potential, from which the stability of the used formulations was inferred by following the procedure (See: Mohammed I, Abdel-Azeim S, Shehri D Al, Mahmoud M, Kamal M S, Alade O S, et al. Calcite-Brine Interface and Its Implications in Oilfield Applications: Insights from Zeta Potential Experiments and Molecular Dynamics Simulations. Energy & Fuels 2022, which is incorporated herein by reference in its entirety). The Anton Paar Litesizer 500 instrument uses the phase analysis light scattering (PALS) technique and applies an electric voltage across the cell to determine the electrophoretic mobility of the charged colloidal suspension. The respective formulations were sonicated using the ultrasonic apparatus for ζ minutes to make a homogeneous solution at ambient conditions. Based on the Smoluchowsky model, the (potential was measured at 25° C. with each measurement repeated three times, and the mean value was taken as the & potential within a ±2 mV standard deviation.

### Example 5: Interfacial Time (IFT) Measurement

The IFT is determined using the Biolin Scientific equipment. The IFT exists between two liquid phases. These phases are oil/brine and oil plus the nanofluids at various XG biopolymer concentrations. The IFT is measured in (dyne/cm or mN/m) and is a function of salinity, temperature, pressure, and concentration of the sample phases. A low IFT indicates a high capillary number which favors oil mobility in the reservoir. The IFT results obtained were recorded every 6 seconds for 10 minutes and plotted against time until a stable and steady state was reached. The uncertainty of the measurement was approximately +0.002 dynes/cm.

### Example 6: Rheological Property Measurements

The first step in modifying the chemical structure of the polymer was to tune its rheological properties. The Dynamic Mechanical Analyzer “MCR702e”, Anton Paar, which is an advanced combined motor and transducer rheometer consisting of a primary instrument and a separate electronics box was used to measure the changes in viscosity that followed changes in the shear rate (1 up to 100 s⁻¹) at different temperatures: from 30° C. to 80° C. and within 30 minutes of each experiment. After selecting coaxial cylinder geometry, 20 ml was loaded onto the cone cup to ensure that the rotor was lower. The air pressure was adjusted at 30 psi to make sure the rheometer was at zero. Thereafter, the measurement was obtained, and the results were displayed in an automated spreadsheet.

### Example 7: Core Flooding Experiment

Referring to FIG. 3, two Berea sandstone cores (Korcerk, USA) were used for this experiment and the experimental schematic is as shown in FIG. 3. The properties of the core sample are presented in Table 2. Initially, the core sample was cut and oven-dried at 50° C. for 3 days. Further, the core sample was measured and placed in the core holder and overburden pressure was applied. A vacuum was applied to the core for 24 hours to remove any air. The core was saturated with a brine of 3 wt. % NaCl concentration and then flooded with 19° API Arab light crude oil (drainage) until the core reached residual water saturation (S_wi). Furthermore, the oil-saturated cores were aged for 5 days to 7 days. At this point, the core was saturated with oil and ready for flooding. Subsequently, the process of imbibition began by flooding with 3 wt. % NaCl brine at an injection rate of 0.25 cm³/min until it was near residual oil saturation (Sₒᵣ) and ready for nanofluid/biopolymer solution treatment. The pore volume (PV) of the injected brine was around 3 PV to 4 PV for both experiments. Traditionally, brine flooding stopped when only a trace of oil was being produced. Moreover, the process of injection continued, nanofluid of different concentrations at an injection rate of 0.25 cm³/min were injected into the core. In particular, post-flooding with brine was conducted to ensure that no oil remains in the tube and core gets collected in the accumulator. Table 2 refers to the properties of cores used in the above example.

TABLE 2
The properties of the sandstone cores

| | | | Dry | Pore | | Perme- |
|---|---|---|---|---|---|---|
| Core | Length | Diameter | weight | volume | Porosity | ability |
| No. | (cm) | (cm) | (g) | (cm³) | (%) | (mD) |
| 1 | 14.98 | 3.62 | 376.661 | 27.863 | 18.07 | 71.381 |
| 2 | 15.01 | 3.60 | 376.653 | 27.836 | 18.22 | 66.963 |

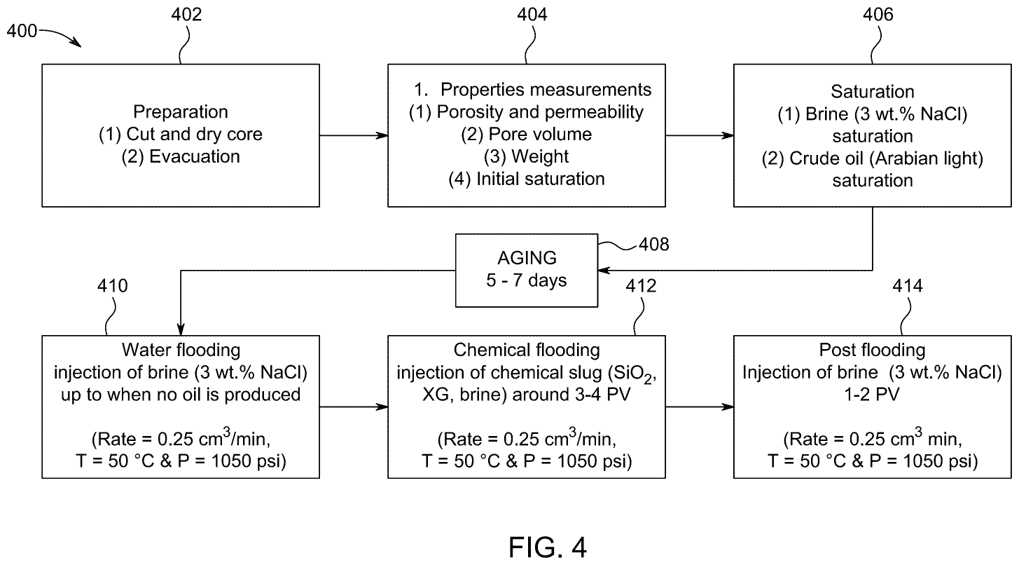

Referring to FIG. 4, a schematic block diagram of a process 400 of flooding the core is illustrated, according to certain embodiments. At block 402, the process 400 includes preparation of the core. The preparation includes two steps—(i) referring to cutting and drying the core; and (ii) evacuation of the core. At block 404, the process 400 includes measurement of the properties of the core. The properties of the core include porosity of the core, permeability of the core, pore volume, weight of the core, and initial saturation of the core. At block 406, the process 400 includes saturation of the core. The core used in this instance can be saturated with a brine solution of 3 wt. % NaCl and Arabian light crude oil. At block 408, the process 400 includes ageing the saturated core for 5 to 7 days. Further, at block 410, the process 400 includes flooding the core with water and brine. The flooding is done by injecting 3 wt. % brine solution up until no more oil can be obtained from the core. The rate at which the flooding is done is 0.25 cm³/min at a temperature of 50° C. and a pressure of 1050 psi. At block 412, the process 400 includes flooding the core with chemicals. The flooding is done by injecting chemical slug (SiO₂, XG, brine). The chemical flooding is carried out at a rate of 0.25 cm³/min, temperature of 50° C., and a pressure of 1050 psi. To conclude the flooding of the core, at block 414, the process 400 includes post flooding measures. The post flooding is done by injecting the brine as mentioned above at a rate of 0.25 cm³/min, temperature of 50° C., and a pressure of 1050 psi.

### Example 8: XRD Characterization

Referring to FIG. 5, a graph of XRD spectrum of SiO₂ nanoparticles is illustrated. The XRD spectrum analysis was carried out on the synthesized nanoparticles of SiO₂. The XRD spectrum displays sharp peaks which demonstrates the crystalline structure of the SiO₂ nanoparticles. The peaks at 20 equals to 20.9°, 26.12°, 36.4°, 39.6°, 42.5°, 45.8°, 50.1°, 51.9°, 59.7°, and 68.1° indicate (100), (101), (110), (102), (200), (201), (112), (202), (211), and (022) crystal planes of quartz (Q), as shown in FIG. 5, respectively (See: Meftah N, Mahboub M S. Spectroscopic Characterizations of Sand Dunes Minerals of El-Oued (Northeast Algerian Sahara) by FTIR, XRF and XRD Analyses. Silicon 2020 and Pertahanan U, Arabia S, Studies L, Pertahanan U. Microstructural Study of Red Sand Used As Partial Cement 2010, which is incorporated herein by reference in its entirety). However, the peak at 2θ equals to 30.2° indicates (104) crystal planes of calcite (C) (See: Matei C, Berger D, Dumbrava A, Radu M D, Gheorghe E. Calcium carbonate as silver carrier in composite materials obtained in green seaweed extract with topical applications. J Sol-Gel Sci Technol 2020 and Kezuka Y, Kawai K, Eguchi K, Tajika M. Fabrication of single-crystalline calcite needle-like particles using the aragonite-calcite phase transition. Minerals 2017, each of which is incorporated herein by reference in their entireties).

Referring to FIGS. 6A-6C, transmission electron microscope (TEM) and high-resolution transmission electron microscope (HRTEM) micrographs of SiO₂ nanoparticles are illustrated. The TEM micrographic image shows the range of the SiO₂ nanoparticles is between 8 nm to 250 nm, which indicates nano and sub-nano particles as shown in FIG. 6A-4B. The HRTEM micrographic image shows a further improvement of the crystal structure by showing an improved uniform lattice structure, as depicted in FIG. 6C. The filtered lattice image in FIG. 6C is a high-resolution depiction of the SiO₂ nanoparticles micrograph of FIG. 6B. Accordingly, the lattice spacings values were 0.34 nm (102) crystal planes of Q and 0.23 nm (101) of the crystal plane of Q (See: Aggarwal Y, Siddique R. Microstructure and properties of concrete using bottom ash and waste foundry sand as partial replacement of fine aggregates. Constr Build Mater 2014, which is incorporated herein by reference in its entirety). The lattice spacings values (0.34 nm and 0.23 nm) are compatible with the XRD spectrum results as shown in FIG. 5 and verify the crystalline nature of the sample.

Moreover, nanoparticle stability is one of the obstacles encountered in nanofluid deployment in the oil industry because it tends to aggregate and deposit in the base fluid (See: Kamatchi R, Venkatachalapathy S. Parametric study of pool boiling heat transfer with nanofluids for the enhancement of critical heat flux: A review. Int J Therm Sci 2015). However, ζ potential is used as a fundamental indicator of the stability of such colloidal dispersion. The ζ potential measures the magnitude of electrostatic forces (attraction/repulsion) on the colloidal system (See: Nasralla R A, Nasr-El-Din H A. Double-layer expansion: Is it a primary mechanism of improved oil recovery by low-salinity waterflooding? SPE Reserve Eval Eng 2014). It can be measured using several methods (electrophoresis, electroacoustic, electroosmosis, and streaming potential) depending on the particle size (See: Mohammed I, Al Shehri D, Mahmoud M, Kamal M S, Alade O S. Impact of Iron Minerals in Promoting Wettability Alterations in Reservoir Formations. ACS Omega 2021, which is incorporated herein by reference in its entirety). For instance, the streaming potential is employed for a coarse particle whereas electrophoresis is used for fine particles to enable particle suspension in the solutions. A large positive value or negative value of ζ potential above ±30 mV is considered to indicate good physical colloidal stability whereas values less than ±30 mV can result in particle aggregation, flocculation, and precipitation due to the van der Waal forces of attraction. Referring to Table 3, displaying the inference of colloidal stability from the ζ potential values.

TABLE 3
A measure of colloidal system stability values.

| Zeta (ζ) potential (mV) | Stability behavior of colloidal systems |
|---|---|
| From (0 to ±5) | Rapid coagulation (flocculation) |
| From (±10 to ±30) | Incipient stability |
| From (±30 to ±40) | Moderate stability |
| From (±40 to ±60) | Good stability |
| Greater than (±61) | Excellent stability |

The stability of SiO₂ nanoparticles is highly dependent on several parameters such as the dispersant fluid composition, pH, and NPs concentration (See: Mukherjee S. Preparation and Stability of Nanofluids-A Review. IOSR J Mech Civ Eng 2013). In an example, the ζ potential of 0.05 wt. % SiO₂ dispersed in a 3 wt. % NaCl solution was determined to be −13.6 mV, which is the value of quartz particles in a similar dispersant fluid (See: Mohammed I, Al Shehri D A, Mahmoud M, Kamal M S, Alade O. Surface Charge Investigation of Reservoir Rock Minerals. Energy and Fuels 2021). Further, from the magnitude of the observed ζ potential value, the particle within the suspension is slightly stable. Referring to Table 4, a plurality of formulations was determined.

TABLE 4
Zeta potential measurement for the experimental formulations.

| | XG concentration | Zeta |
|---|---|---|
| Samples | (wt. %) | potential (mV) |
| Brine (3%) + NPs (0.05%) | 0.00 | −13.60 |
| Brine (3%) + NPs (0.05%) + XG | 0.08 | −16.10 |
| Brine (3%) + NPs (0.05%) + XG | 0.10 | −16.90 |
| Brine (3%) + NPs (0.05%) + XG | 0.12 | −14.80 |
| Brine (3%) + NPs (0.05%) + XG | 0.14 | −13.40 |
| Brine (3%) + NPs (0.05%) + XG | 0.16 | −14.00 |

Referring to FIG. 7, a bar graph representing the aforementioned zeta potential values is illustrated. As can be observed from FIG. 7, the XG concentration of 0.10 wt. % provided higher stability (−16.9 mV). A decrease in colloidal stability was observed as the XG concentration increased from 0.12 wt. % (−14.8 mV) to 0.14 wt. %, (−13.4 mV), respectively. This can be attributed to the compression of the double layer. Furthermore, this observation suggests that beyond the XG concentration of 0.10 wt. %, the nanoparticle stability in the suspension is altered thus, the carrying capacity of the formulation to stimulate oil recovery is hindered. However, at 0.16 XG wt. %, a change from −13.4 mV to −14.0 mV was recorded. In conclusion, the biopolymer behavior contributes to the stability of the formulations since a uniform concentration of NPs was tested in this experiment. Moreover, this supports the hypothesis that, beyond 0.10 wt. % XG concentration for a uniform NPs quantity, there exists a form of agglomeration which in return leads to low ζ potential.

In some embodiments, IFT measurement amongst the formulation was conducted to select a preferred concentration for the core flood experiment. The IFT was measured at low concentrations because it is difficult to produce a stable pendant at a higher concentration. Also, ultra-low IFT values cannot be achieved especially when using polymers compared to surfactant. Referring to Table 5, five samples of nanofluids formulations at several XG biopolymer concentrations from 0.08 g/100 mL to 0.16 g/100 mL were prepared, as illustrated in Table 5. The first value at 0.00 g/100 mL which equals 20.16 dynes/cm was used as a reference value. Conventionally, an oil-brine IFT of 27 dynes/cm is within the normal range for different crude oil-brine systems as reported by Donaldsons et al. (See: Donaldson E C, Thomas R D, Lorenz P B, Wettability Determination and Its Effect on Recovery Efficiency. Soc Pet Eng J 1969). However, lower IFT values (19.2 dynes/cm) between crude oil and brine have also been reported (See: Hendraningrat L, Li S, Torsæter O. A core flood investigation of nanofluid enhanced oil recovery. J Pet Sci Eng 2013).

TABLE 5
IFT values for different nanofluid formulations
at constant 3 wt. % NaCl and 0.05 wt. % SiO₂

| | XG concentration | IFT |
|---|---|---|
| Samples | (wt. %) | (dynes/cm) |
| Brine (3% NaCl) plus crude | 0.00 | 20.160 |
| Brine (3%) + NPs (0.05%) + XG | 0.08 | 10.120 |
| Brine (3%) + NPs (0.05%) + XG | 0.10 | 9.282 |
| Brine (3%) + NPs (0.05%) + XG | 0.12 | 10.267 |
| Brine (3%) + NPs (0.05%) + XG | 0.14 | 9.933 |
| Brine (3%) + NPs (0.05%) + XG | 0.16 | 9.981 |

The IFT measurements were taken in a condition (e.g., preferably ambient pressure and 20° C. temperature) with a constant salinity (e.g., preferably about 3 wt. % NaCl), and NPs concentration (e.g., preferably about 0.05 wt. % SiO₂), at varying XG concentrations. The IFT decreased substantially by about 10.04 dynes/cm (from 20.160 to 10.120 dynes/cm) at the beginning of bio-polymer concentration. Further, the IFT reduced gradually to 9.282 dynes/cm at an XG concentration of 0.10 wt. %. However, the IFT increased gradually to 10.267 dynes/cm at 0.12 wt. % when the bio-polymer concentration increased. Subsequently, a subtle decrease (9.933 dynes/cm) was observed at 0.14 wt. %, before rising to a stable value of 9.981 dynes/cm. A further increase in XG concentration may maintain optimal IFT values as the possibility of fluid saturation is attained.

Referring to FIG. 8, a graph of IFT nanofluid formulations of 3 wt. % NaCl and 0.05 wt. % SiO₂ at a plurality of XG concentrations is illustrated. As can be observed from FIG. 8, the nanofluid formulation with 0.10 wt. % biopolymer has the lowest IFT value in the formulation. This result also corresponds with the zeta potential stability measured for this XG biopolymer concentration (−16.9 mV). Further, the carrying capacity of 0.10 wt. % XG will provide representative stability of the colloidal dispersion without excessive cost as in the case of 0.14 wt. % XG and 0.16 wt. % XG respectively, which also has lower IFT, however, not as low as compared to 0.10 wt. % XG.

In some embodiments, the assessment of the viscoelastic character of fluids and polymeric materials relies on rheological measurements. Characterizing the structure and properties of nanofluids relies on an understanding of the flow behavior and dynamics of constituent particles in the suspension of nanofluids. Particle migration and transport in nanofluids may have an effect on the rheological behavior of the suspension. Further, mobility is considered to be one of the major factors for tuning the effectiveness of a polymer flood as the primary goal of adding polymers to water is to increase the viscosity of water and subsequently decrease the mobility ratio.

Referring to FIG. 9, a graph depicting the effects of temperature on the viscosity of the nanofluids formulations (result of the rheology measurement) is illustrated. The change in viscosity of the XG was investigated by varying the temperature at different shear rates. The temperature was adjusted to 30° C., 40° C., 50° C., 60° C., 70° C., and 80° C. For each test, 20 mL of XG solution was used. As can be observed from FIG. 9, as the temperature increased, the viscosity of the XG solution decreased (See: Muhammed N S, Haq M B, Al-Shehri D, Rahaman M M, Keshavarz A, Hossain S M Z. Comparative Study of Green and Synthetic Polymers for Enhanced Oil Recovery. Polymers (Basel), Kamal M S, Adewunmi A A, Sultan A S, Al-Hamad M F, Mehmood U. Recent advances in nanoparticles enhanced oil recovery: Rheology, interfacial tension, oil recovery, and wettability alteration. J Nanometer 2017, and Gbadamosi A, Patil S, Kamal M S, Adewunmi A A, Yusuff A S, Agi A, et al. Application of Polymers for Chemical Enhanced Oil Recovery). To examine the effect of NPs at a given temperature, 0.05 wt. % SiO₂ was added to the prepared XG and NaCl solutions, and the viscosities were measured at different shear rates and temperatures. Though, it has been reported that monovalent electrolyte such as NaCl at various XG concentration is not obvious (Muhammed N S, Haq M B, Al-Shehri D, Rahaman M M, Keshavarz A, Hossain S M Z. Comparative Study of Green and Synthetic Polymers for Enhanced Oil Recovery. Polymers (Basel) 2020; 12:2429), the effect of SiO₂ NP significantly impact the carrying capacity of the nanofluids as all observed values were greater than those without NPs.

For instance, at 30° C., the viscosity decreased from 5.79 mPa·s to 2.94 mPa·s when the shear rate increased from 1 s⁻¹ to 100 s⁻¹ at XG plus NaCl plus SiO₂ mixtures, whereas the viscosity decreased from 5.62 mPa·s to 2.52 mPas when the shear rate increased from 1 s⁻¹ to 100 s⁻¹ for XG plus NaCl mixtures. A similar trend was observed for other temperatures, however, the difference in viscosity changes increased with temperature with the most recorded at the highest temperature (80° C.). In an example, at a constant shear rate (10 s⁻¹), the viscosity difference systematically increased with temperature by 0.35 mPa·s (from 4.13 mPa·s with NPs to 3.78 mPa·s without NPs) at 30° C. and 0.74 mPa·s (from 2.48 mPa·s with NPs to 1.74 mPa·s without NPs) at 80° C., respectively. This observation could be attributed to the effect of SiO₂ which significantly reduced the viscosity at elevated temperatures. Moreover, the presence of monovalent ions creates a barrier on the double layer of the electrolytes where the extension reduces intermittently, thus, reducing the ability of the polymer molecules to stretch to occupy more space, hence reduction in viscosity. This effect also supports the claim that monovalent electrolyte has minimal impact on thermal stability (See: Said M, Haq B, Al Shehri D, Rahman M M, Muhammed N S, Mahmoud M. Modification of Xanthan Gum for a High-Temperature and High-Salinity Reservoir. Polymers (Basel) and Seright R S, Henrici B J. Xanthan stability at elevated temperatures. SPE Reserve Eng (Society Pet Eng 1990)).

In some embodiments, core flooding simulates reservoir conditions, which aids in the investigation of the EOR capabilities of polymer systems. To examine and contrast the recoveries of the formulations, two core flood experiments were carried out. In the first formulation (0.10 wt. % XG+3 wt. % NaCl), the sandstone core was fully saturated with 3 wt. % NaCl brine followed by flooding with crude oil, until the core reached residual water saturation. The S_{wr} and Sₒᵢ measured were 23.5% and 76.5%, respectively. To simulate the water flooding stage, the oil-saturated core was flooded with 3 wt. % NaCl brine until it was near residual oil saturation. Note that S_{wr} and Sₒᵢ measured were 23.5% and 76.5%, respectively. To simulate the water flooding stage, the oil-saturated core was flooded with 3 wt. % NaCl brine until it was near residual oil saturation. Referring to FIG. 10, a graph of total oil production from the core after flooding with the XG and NaCl blend is illustrated. The flooding stopped when only a trace amount of oil was produced. After the water flooding stage was complete, the secondary oil recovery was 51.6% of the OOIP. However, the base case formulation (at the tertiary phase), resulted in an incremental oil recovery of 8.24% and a total oil recovery of 59.84%. Referring to Table 6, the details of the amount of oil recovered and fluid saturations at different stages is provided.

TABLE 6
Flood results for 0.10 wt. % XG + 3 wt. % NaCl brine blend.

| | | Oil | | Water Flood | | Brine plus XG | | |
|---|---|---|---|---|---|---|---|---|
| | PV | Volume | Sₒᵢ | Recovery | | Flood Recovery | | Total |
| Core | (cm³) | (cm³) | (%) | cm³ | % | cm³ | % | % |
| S1 | 27.8628 | 21.3 | 76.50 | 10.99 | 51.6 | 1.75 | 8.24 | 59.84 |

Referring to Table 7, the outcome of the second formulation (0.05 wt. % SiO₂+0.10 wt. % XG+3 wt. % NaCl) is summarized in Table 7 and FIG. 11. Herein, the S_{wr} and Sₒᵢ were 19.2% and 80.83%, respectively. After aging the oil-saturated core sample, about 3 to 4 PV of 3 wt. % NaCl brine was injected until no oil was produced. Then the core was flushed with formulation II with 3 PV until no more oil was produced. After that, a post-flood (1 PV) of 3 wt. % NaCl brine was injected to ensure all the mobile oil was produced. The recovery obtained via water flooding was 50.8% of the OOIP, and the tertiary oil recovery was 12.80% OOIP. The total oil recovery by the water and 0.05 wt. % SiO₂+0.10 wt. % XG+3 wt. % NaCl formulation resulted in 63.60% OOIP.

TABLE 7
Flood results for 0.05 wt. % SiO₂ + 0.10 wt. % XG + 3 wt. % NaCl brine mixture

| | | Oil | | Water Flood | | Brine plus XG plus | | |
|---|---|---|---|---|---|---|---|---|
| | PV | Volume | Soi | Recovery | | NP Flood Recovery | | Total |
| Core | (cm³) | (cm³) | (%) | cm³ | % | cm³ | % | % |
| S2 | 27.836 | 22.5 | 80.83 | 11.43 | 50.8 | 2.88 | 12.8 | 63.60 |

The oil recovery performance for the two formulation (formulation I and formulation II) is shown in Table 8. A factor, which might affect the result is the initial oil saturation of the core samples. As can be seen in Table 8, the core samples approximately recorded similar pore volumes, yet produced different oil saturations. This could be attributed to the different permeabilities, as core 1 (71.381 mD) was more porous than core 2 (66.963 mD). Hence, less initial oil recovery is to be expected.

TABLE 8
Summary of the two formulations

| | | | | | | Tertiary | | |
|---|---|---|---|---|---|---|---|---|
| | | Oil | | Water Flood | | Flood | | |
| | PV | Volume | Sₒᵢ | Recovery | | Recovery | | Total |
| Formulation | (cm³) | (cm³) | (%) | cm³ | % | cm³ | % | % |
| XG + 3% | 27.863 | 21.3 | 76.50 | 10.99 | 51.6 | 1.75 | 8.24 | 59.84 |
| NaCl | | | | | | | | |
| XG + 3% | 27.836 | 22.5 | 80.83 | 11.43 | 50.8 | 2.88 | 12.8 | 63.60 |
| NaCl + SiO₂ | | | | | | | | |

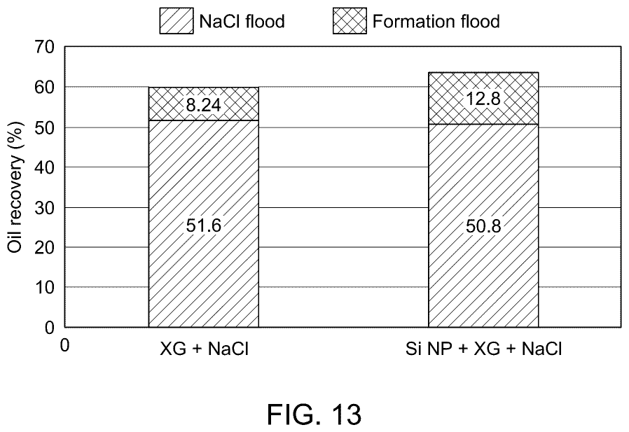

Referring to FIG. 12, a graph of a comparative analysis of total oil recovery observed from the two formulations is illustrated. As can be seen from FIG. 12, the oil recovery at the different stages (secondary and tertiary), is illustrated. It can be observed that at the end of the waterflood, formulation I recorded 51.6% while formulation II was 50.8%. Though this shows that the formulation I is a better agent in the secondary stage, however, the formulation I recorded lower incremental oil recovery in the tertiary stage. This shows that the formulation II which combines the effect of SiO₂ NPs has a better carrying capacity as it easily penetrates the pores of the reservoir. Moreover, IFT and zeta potential results, also indicate the addition of SiO₂ at this biopolymer concentration (0.10 wt. %) to effectively stimulates the residual oil production as the nanofluid mixture is more stable.

Referring to FIG. 13, a bar graph of comparative analysis of total oil recoveries using the two formulations is illustrated, according to certain embodiments. As can be seen from FIG. 13, the formulation II produces better results. Overall, this reveals that xanthan gum performs better in presence of SiO₂ nanoparticles which is suitable for the GEOR.

The present disclosure examined the role of biopolymer (XG)-nanoparticle (SiO₂) coating as a GEOR technology for residual oil production. Zeta potential measurement shows that 0.10 wt. % XG provided improved stability when combined with a fixed SiO₂ nanoparticles at a concentration of 0.05 wt. % for effective carrying capacity and ease in penetration within the pores of the core sample. IFT shows that a lower value at 0.10 wt. % XG has a better recovery to achieve an improved oil stimulation. The rheological study shows that 3 wt. % NaCl brine (monovalent ion) had less impact on the reservoir temperature at varying XG concentrations. However, the addition of 0.05 wt. % SiO₂ shows the impact of the carrying capacity of the nanofluids as some of the observed values were higher than those without nanoparticles. The core flooding shows that formulation II (0.05 wt. % SiO₂+0.10 wt. % XG+3 wt. % NaCl) offered a higher rate of oil recovery in the tertiary stage compared to formulation I (0.10 wt. % XG+3 wt. % NaCl). Specifically, formulation II recovered, e.g., preferably about 4.5% more of the OOIP compared to formulation I. This, therefore, shows that the xanthan gum biopolymer may have an improved performance in the presence of SiO₂ nanoparticles and can boost more residual oil.

Numerous modifications and variations of the present disclosure are possible in light of the above teachings. It is therefore to be understood that within the scope of the appended claims, the invention may be practiced otherwise than as specifically described herein.

1: A method for green enhanced oil recovery from a hydrocarbon reservoir in a subterranean geologic formation, comprising:
injecting a nanofluid composition into the geologic formation via an injection well;
wherein the geologic formation includes the injection well, a production well, and the hydrocarbon reservoir, wherein the hydrocarbon reservoir contains a hydrocarbon composition;
wherein an interfacial tension (IFT) of the hydrocarbon composition and the nanofluid composition is about 48 to 55% less than the IFT of the hydrocarbon composition and a brine as determined by the pendant drop method;
wherein the nanofluid composition comprises silicon oxide (SiO₂) nanoparticles (NPs), and xanthan gum;
wherein the SiO₂ NPs are prepared by ball milling red sand dune sand; and
collecting the hydrocarbon composition from the reservoir via the production well.

2: The method of claim 1, wherein the nanofluid composition comprises:
about 0.05 wt. % of SiO₂ NPs;
about 0.08 to 0.16 wt. % of the xanthan gum; and
about 3 wt. % of a water-soluble mineral, wherein each wt. % is based on a total weight of the nanofluid composition.

3: The method of claim 2, wherein the water-soluble mineral comprises one or more of sodium chloride, potassium chloride, calcium chloride, magnesium chloride, sodium bromide, and potassium bromide.

4: The method of claim 1, wherein the SiO₂ NPs have a uniform crystalline lattice structure and an average particle size of 8 to 250 nanometers (nm).

5: The method of claim 1, wherein the SiO₂ NPs present in the nanofluid composition are disposed on surfaces of particles of the xanthan gum.

6: The method of claim 1, wherein the xanthan gum has an average molecular weight in a range of 10,000 Da to 1,000,000 Daltons (Da).

7: The method of claim 1, wherein the nanofluid composition is injected into the reservoir at an injection rate of about 0.25 cubic centimeters per minute (cm³/min) under a temperature of about 50 degrees Celsius (° C.), and a pressure of about 1050 pounds per square inch (psi).

8: The method of claim 1, wherein the nanofluid composition has a zeta (2) potential of −13 to −17 millivolts (mV) measured at about 25° C.

9: The method of claim 1, wherein the nanofluid composition has a pH of 5 to 6.

10: The method of claim 1, wherein the nanofluid composition has a viscosity of 1.000 to 1.020 mPa·s at a temperature of 20 to 25° C.

11: The method of claim 1, wherein the nanofluid composition further comprises one or more selected from the group consisting of a foaming agent, a gelling agent, a pH control agent, a breaker, an oxidizing breaker, a fluid loss control additive, a clay stabilizer, a corrosion inhibitor, a crosslinking agent, a scale inhibitor, a catalyst, a surfactant, a preservative, a biocide, a thermal stabilizer, and a combination thereof.

12: The method of claim 1, wherein the IFT of the hydrocarbon composition and the nanofluid composition is in a range of 9 to 10.5 dynes per centimeter (dynes/cm).

13: The method of claim 1, wherein the reservoir is at least one selected from the group consisting of a sandstone reservoir and a carbonate reservoir.

14: The method of claim 1, wherein the geological formation of the reservoir comprises a rock material selected from the group consisting of Bentheimer sandstone, Berea sandstone, Vosges sandstone, quartz, borosilicate glass, basalt, shale, calcite, granite, dolomite, gypsum, anhydrite, mica, kaolinite, illite, montmorillonite, and coal.

15: The method of claim 1, wherein the geological formation has:
a pore volume of about 27.5 to 28 cubic centimeters (cm³);
a porosity of 18 to 18.5% based on a total volume of the geological formation; and
a permeability of 60 to 80 millidarcy (mD).

16: The method of claim 1, wherein the hydrocarbon composition comprises Arab light crude oil.

17: The method of claim 16, wherein the method recovers 5 to 15% more of the original oil in place (OOIP) than a method in the absence of the injecting of the nanofluid composition.

18: The method of claim 1, further comprising
preparing the nanofluid composition by:
ball-milling red sand dune sand with zirconium (Zr) balls having an average size (diameter) of 600 to 800 micrometers (μm) to form the SiO₂ NPs;
dispersing the SiO₂ NPs in an aqueous liquid containing a water-soluble mineral to form a dispersion; and
mixing the xanthan gum and the dispersion to form the nanofluid composition.

19: The method of claim 18, wherein a mass ratio of the red sand dune sand to the Zr balls during the ball-milling is about 20:1.

20: The method of claim 18, wherein the ball-milling is carried out at about 3000 revolutions per minute (rpm) for about 12 to 18 hours.
